(19) United States
(12) Patent Application Publication
(10) Pub. No.: US 2026/0306986 A1
(43) Pub. Date: Oct. 8, 2026

(54) FILTER ELEMENT FOR USE WITH DUST COLLECTOR & OTHER APPLICATIONS

(71) Applicant: Donaldson Company, Inc., Bloomington, MN (US)

(72) Inventors: Kevin Fletcher, Kingston upon Hull (GB); Nicolas Van der veken, Brussels (BE); Eckhard Kolb, Brussels (BE)

(21) Appl. No.: 19/636,412

(22) Filed: Apr. 1, 2026

Related U.S. Application Data
(60) Provisional application No. 63/782,445, filed on Apr. 2, 2025.

(51) Int. Cl. B01D 46/52; B01D 46/00

(52) U.S. Cl. CPC B01D 46/525; B01D 46/0002; B01D 2271/022

(57) ABSTRACT

A filter element includes a media pack having first and second opposite axial ends to provide straight through filter flow; and a side wall extending between the first and second axial ends. The media pack has first and second opposite flow faces. A gasket support is secured to the media pack. The gasket support has an annular wall and a plate extending radially away from the media pack. A gasket member is secured to a second axial surface of the plate. The gasket member is radially spaced from the annular wall of the gasket support and from the side wall of the media pack by a receiving cavity, and extends in a direction toward the media pack. A deflector is secured to the first flow face.

This application claims priority to US 63/782,445, filed Apr. 2, 2025 and is incorporated herein by reference.

### FIELD OF THE DISCLOSURE

The present disclosure relates to filter arrangements, typically for use in filtering air; such as removal of dust. Also disclosed are methods of use and servicing.

### BACKGROUND

Dust collectors include systems that take in unfiltered air, filter it, and exhaust clean air. Dust collectors are used in a variety of environments, including factories, for example. These systems often have one or more filter elements that are periodically changed out. These systems also sometimes use pressurized gas to direct a pulse of gas (air) from the downstream side of the filter element to the upstream side. This helps to remove some of the dust and debris collected on the upstream side of the filter element, which allows the filter element to be used longer before the restriction becomes so high that it needs to be changed. Examples of such air filters assemblies are disclosed in, for example, U.S. Pat. Nos. 9,283,503; 6,090,173; 4,218,227; 4,395,269; 5,980,598; 6,322,618; DE 3905113; and Patent Publication U.S. 2006/0112667Al, each of these patent documents being incorporated by reference herein. Improvements in filter elements and dust collectors and methods are desirable.

### SUMMARY

In general, a filter element is provided that improves the prior art.

In one aspect, the filter element includes a media pack having first and second opposite axial ends to provide straight through filter flow; and a side wall extending between the first and second axial ends. The media pack has first and second opposite flow faces and a plurality of flutes; each of the flutes having a first portion adjacent to the first flow face and a second portion adjacent to second flow face; selected ones of the flutes being open at the first portion and closed at the second portion, and adjacent flutes being closed at the first portion and open at the second portion. The first flow face is an outflow face, and the second flow face is an inflow face. A gasket support is secured to the media pack; the gasket support having an annular wall and a plate extending radially therefrom and away from the media pack. The plate has a first axial surface away from the media pack, and an opposite second axial surface toward the annular wall. A gasket member is secured to the second axial surface of the plate; the gasket member being radially spaced from the annular wall of the gasket support and from the side wall of the media pack by a receiving cavity, and extending in a direction toward the media pack. A deflector is secured to the first flow face.

In some examples, the filter element further includes a center bar extending across the first flow face.

In one or more embodiments, the center bar is an integral part of the gasket support.

In some embodiments, the annular wall of the gasket support has an inner wall surface facing the side wall of the media pack and an opposite outer wall surface facing the gasket member, with the receiving cavity being between the outer wall surface and the gasket member.

In some examples, the gasket support further includes a lip extending radially inwardly from the annular wall; the lip being oriented on a portion of the first flow face.

In one or more embodiments, the center bar bisects the first flow face and extends from the lip of the gasket support.

In some embodiments, the deflector is connected to the center bar.

In some examples, the deflector has a curved, solid surface projecting from the first flow face.

Some embodiments may further include a handle secured to the media pack.

In one or more embodiments, the handle is an integral part of the gasket support.

In some examples, the handle comprises a tab radially extending from the plate in a direction radially away from the media pack.

In one or more embodiments, the gasket member has opposite straight sides extending from the second axial surface of the plate, joined by a straight terminal surface.

In some example embodiments, the gasket member is only secured to the second axial surface of the plate, and is free of attachment to any other portion of the gasket support.

In some examples, the annular wall has a length longer than a length of the gasket member.

In one or more embodiments, the receiving cavity has an outermost width at least 70% of an outermost width of the gasket member.

In some example embodiments, the receiving cavity has an outermost width at least 80% of an outermost width of the gasket member.

In some examples, the media pack is racetrack shaped, having a pair of first and second parallel sides, joined by opposite first and second curved ends.

In one or more embodiments, the deflector is secured to the first flow face in a region within 25% of a length of the first flow face from the first curved end.

In some embodiments, the tab extends radially from the plate at the second curved end.

In some examples, the center bar extends between the first curved end and second curved end.

In one or more embodiments, the only structure over the first flow face is the center bar and deflector; the first flow face otherwise being open and unobstructed.

In some embodiments, the media pack is polygon shaped.

In some examples, the gasket member is molded to the second axial surface of the plate.

There is no specific requirement that an air cleaner assembly, component therefor, or feature thereof include all of the detail characterized herein, to obtain some advantage according to the present disclosure.

### BRIEF DESCRIPTION OF THE DRAWINGS

FIG. 1 is a perspective view of a filter element having features in accordance with the present disclosure.

FIG. 2 is an end view of the filter element of FIG. 1.

FIG. 3 is a front view of the filter element shown in FIG. 1.

FIG. 4 is a cross-sectional view of the filter element of FIG. 1; the cross-section being taken along the line 4-4 of FIG. 3.

FIG. 5 is an enlarged view of a portion of the filter element, and showing it schematically installed against a tube sheet in a dust collector.

FIG. 6 is a top view of the filter element of FIG. 1.

FIG. 7 a cross-sectional view of the filter element of FIG. 1; the cross-section being taken along line 7-7 of FIG. 6.

FIG. 8 is a fragmentary, schematic, perspective view of a first example media type useable in arrangements according to the present disclosure.

FIG. 9 is an enlarged, schematic, cross-sectional view of a portion of the media type depicted in FIG. 8.

FIG. 10 includes schematic views of examples of various fluted media definitions, for media of the type of FIGS. 8 and 9.

FIG. 11 is a schematic view of an example process for manufacturing media of the type of FIGS. 8-10.

FIG. 12 is a schematic cross-sectional view of an optional end dart for media flutes of the type of FIGS. 8-10.

FIG. 13 is a schematic perspective view of a coiled filter arrangement usable in a filter cartridge having features in accord with the present disclosure, and made with a strip of media for example in accord with FIG. 8.

FIG. 14 is a schematic perspective view of a stacked media pack arrangement usable in a filter arrangement having selected features in accord with the present disclosure and made from a strip of media for example in accord with FIG. 8.

FIG. 15 is a schematic flow end view of a filter media pack using an alternate media to the media of FIG. 8, and alternately usable in selected filter cartridges in accord with the present disclosure.

FIG. 16 is a schematic opposite flow end view to the view of FIG. 15.

FIG. 17 is a schematic cross-sectional view of the media pack of FIGS. 15 and 16.

FIG. 18 is a schematic, fragmentary, cross-sectional view of a further alternate media type usable in a media pack of a filter cartridge having features in accord with the present disclosure.

FIG. 19 is a schematic, fragmentary cross-sectional view, of a first variation of the media type of FIG. 18.

FIG. 20 is a schematic fragmentary depiction of another usable fluted sheet/facing sheet combination in accord with the present disclosure.

FIG. 21 is a fragmentary second schematic view of the type of media in FIG. 20 shown in a media pack.

FIG. 22 is a schematic, fragmentary, plan view of still another media variation usable in arrangements according to the present disclosure.

FIG. 23 is a schematic view of another variation of usable media in accord with the present disclosure.

FIG. 24 is a schematic depiction of another usable fluted sheet/facing sheet combination in accord with the present disclosure.

FIG. 25 is a perspective view of a portion of the usable fluted sheet/facing sheet combination depicted in FIG. 24.

FIG. 26 is a perspective view of another media variation useable in arrangements according to the present disclosure.

FIG. 27 is a schematic, perspective view of a portion of a support section of the filter media of FIG. 26, illustrated in a folded configuration but expanded or separated for illustrative purposes.

FIG. 28 is a schematic, cross-sectional view of a portion of the support section of the filter media of FIG. 26, illustrated in a folded configuration but expanded or separated for illustrative purposes.

FIG. 29 is a perspective view of another media variation useable in arrangements according to the present disclosure.

FIG. 30 is an enlarged view of a portion of the filter element, similar to FIG. 5, but showing an alternatively shaped gasket member.

FIG. 31 is another view, similar to FIG. 5, showing another alternatively shaped gasket member.

FIG. 32 is another view, similar to FIG. 5, showing another alternatively shaped gasket member.

FIG. 33 is another view, similar to FIG. 5, showing another alternatively shaped gasket member.

FIG. 34 is another view, similar to FIG. 5, showing another alternatively shaped gasket member.

FIG. 35 is another view, similar to FIG. 5, showing another alternatively shaped gasket member.

### DETAILED DESCRIPTION

Herein, example filter assemblies, features, and components thereof are described and depicted. A variety of specific features and components are characterized in detail. Many can be applied to provide advantage. There is no specific requirement that the various individual features and components be applied in an overall assembly with all of the features and characteristics described, however, in order to provide for some benefit in accord with the present disclosure.

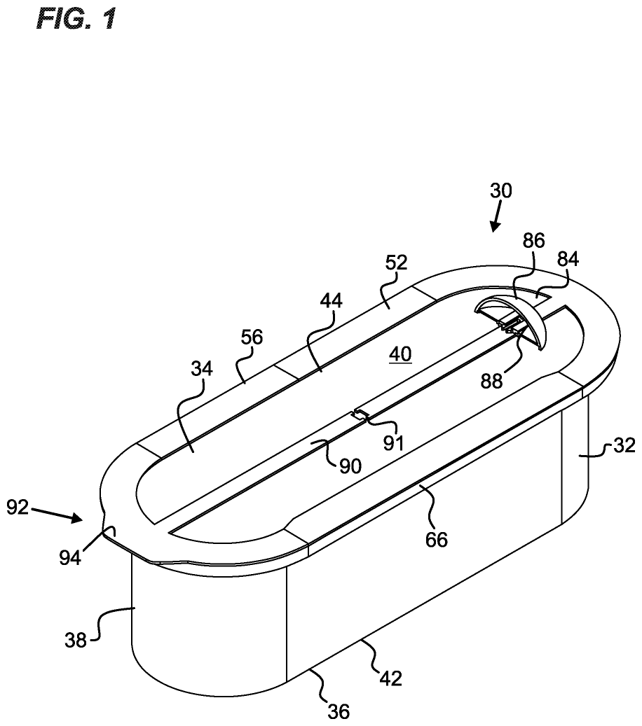

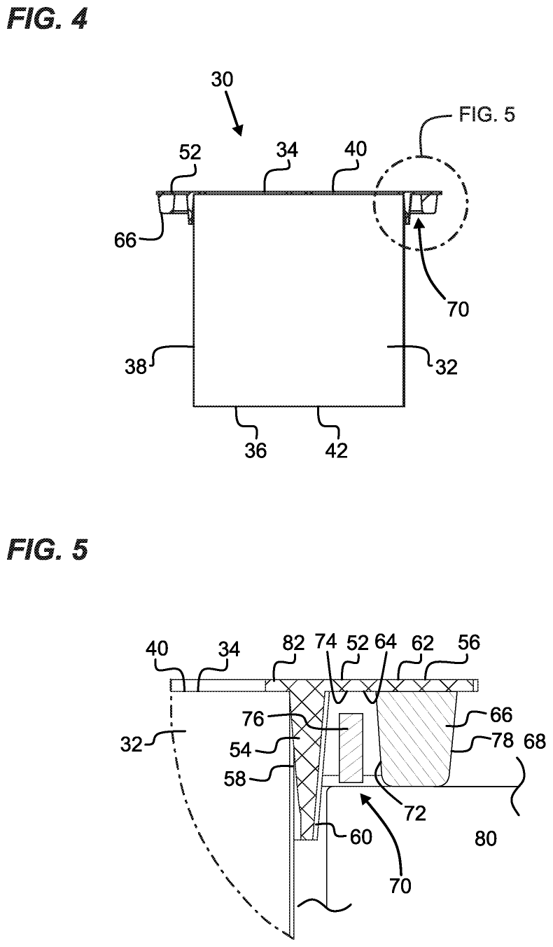

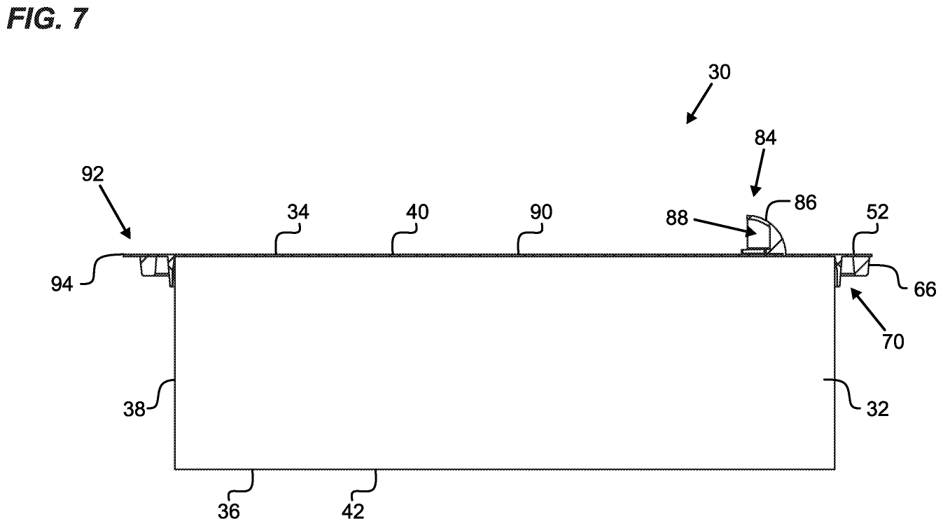

A filter element 30, constructed in accordance with principles of this disclosure, is shown in FIGS. 1-7. The filter element 30 is useable in a dust collector, such as the type shown in U.S. Pat. No. 9,283,503, incorporated herein by reference. The element 30 may be useable in other types of systems, as well.

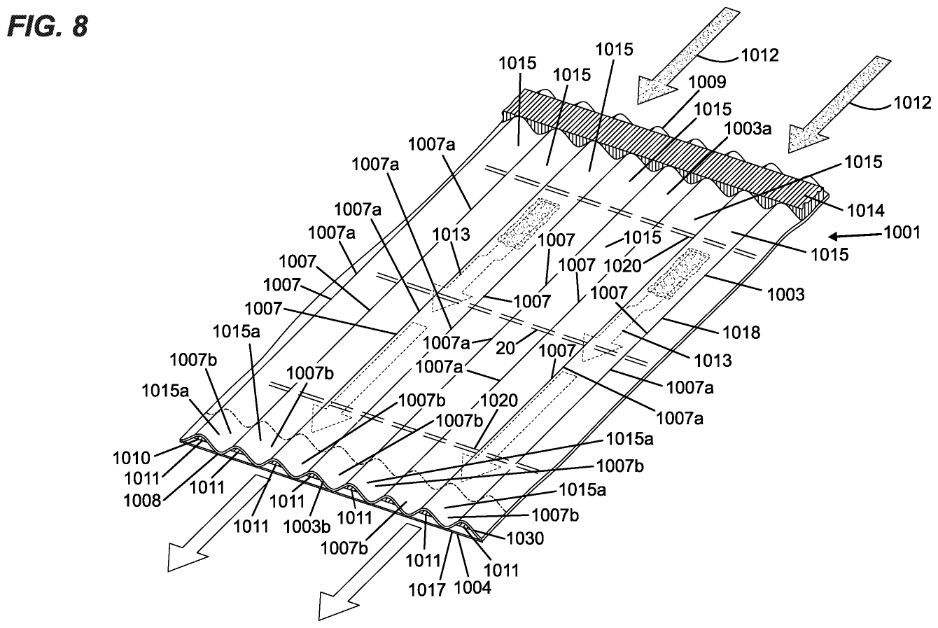

The filter element 30 includes a media pack 32. The media pack 32 is designed to allow fluid (air) to flow through, while removing particulate, such as dust, from the airstream. The media pack 32 can include many different types of filter media, which are discussed below in connection with FIGS. 8-29.

In one example embodiment, the media pack 32 has first and second opposite axial ends 34, 36 to provide straight through filter flow; and a side wall 38 extending between the first and second axial ends 34, 36.

Preferably, the media pack 32 has first and second opposite flow faces 40, 42 and a plurality of flutes 1007 (FIG. 8); each of the flutes having a first portion adjacent to the first flow face 40 and a second portion adjacent to second flow face 42. Selected ones of the flutes 1007 are open at the first portion and closed at the second portion, and selected ones of the flutes 1007 are closed at the first portion and open at the second portion. In the embodiment shown, the flow faces 40, 42 are flat (planar) and parallel to each other. Other embodiments are possible.

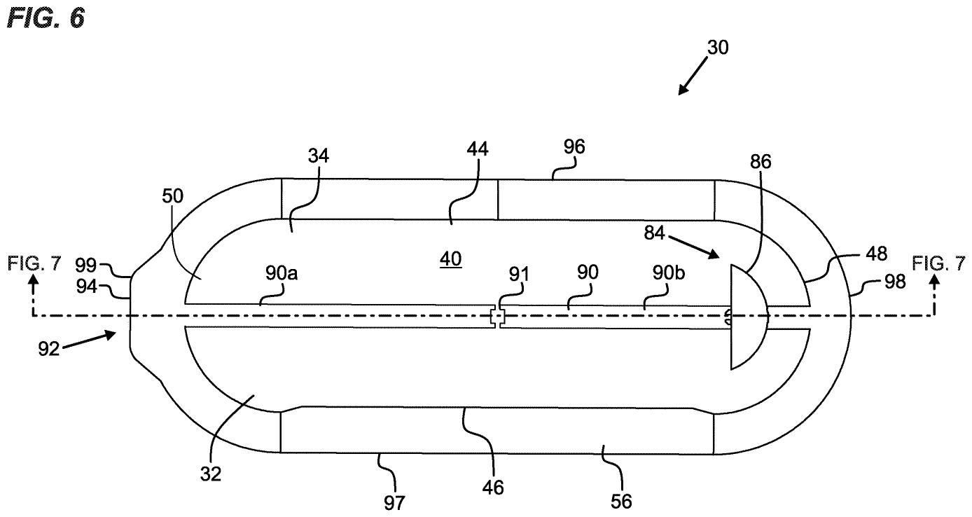

The media pack 32 can have a variety of shapes for its outer perimeter. In the example shown, the media pack 32 is racetrack shaped. Referring now to FIG. 6, the racetrack shape has a pair of first and second parallel sides 44, 46, joined by opposite first and second curved ends 48, 50. In other arrangements, the media pack 32 can be polygon shaped, having a plurality of straight sections joined together. In other arrangements, the media pack 32 can be oval, obround, round, or trapezoid shaped.

In accordance with principles of this disclosure, the filter element 30 has a gasket support 52. The gasket support 52 is secured to the media pack 32. The gasket support 52 can also be described as being a ring, in that it is ring shaped. The gasket support 52 has an annular wall 54 and a plate 56 extending radially therefrom and away from the media pack 32. In FIG. 6, the plate 56 has opposite, parallel straight sides 96, 97, joined by opposite ends 98, 99. End 98 is curved.

In reference now to FIG. 5, the annular wall 54 has an inner wall surface 58 and an opposite outer wall surface 60. The inner wall surface 58 faces the side wall 38 of the media pack 32. In some cases, at least a portion of the inner wall surface 58 is against the side wall 38 of the media pack 32.

The plate 56 has a first axial surface 62 and an opposite second axial surface 64. The first axial surface 62 is oriented to face away from the annular wall 54 and the media pack 32. Preferably, the first axial surface 62 is flat (planar), and is free of any projections, bumps, or extensions therefrom.

The second axial surface 64 is oriented to face toward the annular wall 54. It also faces a direction toward the media pack 32, in that if the outer periphery of the media pack 32 were expanded radially outwardly and the annular wall 54 were removed, the second axial surface 64 would be directly on top of (against) the media pack 32.

In accordance with principles of this disclosure, the filter element 30 has a gasket member 66. The gasket member 66 is used to create a seal against a sealing surface in, for example, a dust collector. The sealing surface can be a tube sheet, a schematic example of a tube sheet being illustrated in FIG. 5 at 68.

The gasket member 66, in the example illustrated, is secured to the second axial surface 64 of the plate 56 and extends downward from the second axial surface 64, when the first axial surface 62 is facing upward. As can be seen in FIG. 5, the gasket member 66 is spaced radially from the annular wall 54 and from the side wall 38 of the media pack 32 to define a receiving cavity 70 between the annular wall 54 and the gasket member 66.

The receiving cavity 70 is defined by 3 surfaces: the outer wall surface 60 of the annular wall 54; a straight, flat section 74 of the second axial surface 64; and an inner radial surface 72 of the gasket member 66. The flat section 74 extends between the outer wall surface 60 and the inner radial surface 72. An outermost width of the receiving cavity 70 is greater than 50% of an outermost width of the gasket member 66; indeed, it can be greater than 60%, 70%, 80%, or 90% of the width of the gasket member 66. The receiving cavity 70 can receive or otherwise accommodate a projection 76 extending from the tube sheet 68. The projection 76 helps to correctly align or position the filter element 30 in an opening of the tube sheet 68.

The gasket member 66 can be various shapes, as illustrated in FIGS. 5 and 30-35. Preferably, and in the example of FIG. 5, the gasket member 66 has opposite straight sides, with one of the straight sides being the inner radial surface 72, and opposite straight side being an outer radial surface 78. The opposite straight sides 72, 78 extend from the second axial surface 64 of the plate 56 and are joined by a straight terminal surface 80. The terminal surface 80 forms an axial sealing surface, which seals against the sealing surface of the tube sheet 68.

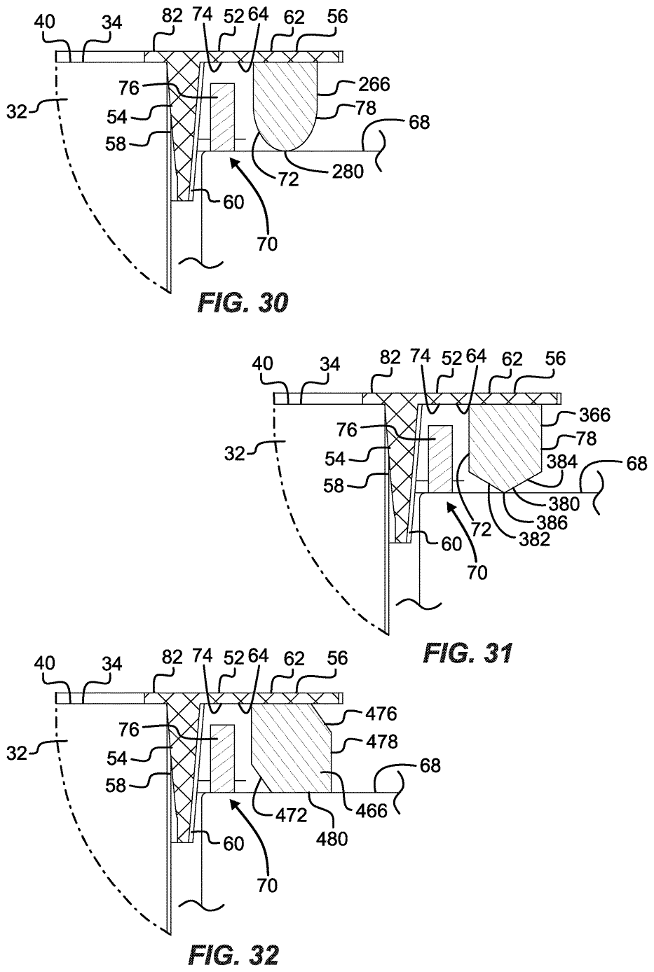

In FIG. 30, instead of straight terminal surface 80 joining the sides 72, 78, the gasket member 266 has a rounded terminal end 280.

FIGS. 31-35 show the gasket member shaped like a polygon, which can be regular or irregular in shape. It should be understood that in each of FIGS. 31-35, any of the intersections or points can be rounded, rather than sharp points (as approximated in the FIGS.) In FIG. 31, instead of straight terminal surface 80 joining the sides 72, 78, the gasket member 366 has a terminal end 380 formed by two, angled straight sides 382, 384 meeting at a point 386. The result is that the gasket member 366 is pentagon shaped, with the point 386 being against the tube sheet 68.

In FIG. 32, the gasket member 466 is shaped like a hexagon, in this case, an irregular hexagon. The gasket member 466 has a straight terminal surface 480 against the tubesheet 68. The inner radial surface has a pair of angled sides 472, 475, meeting at a point. The outer radial surface has a pair of angled sides 476, 478 meeting at a point. The terminal surface 480 extends between and joins side 472 and side 478.

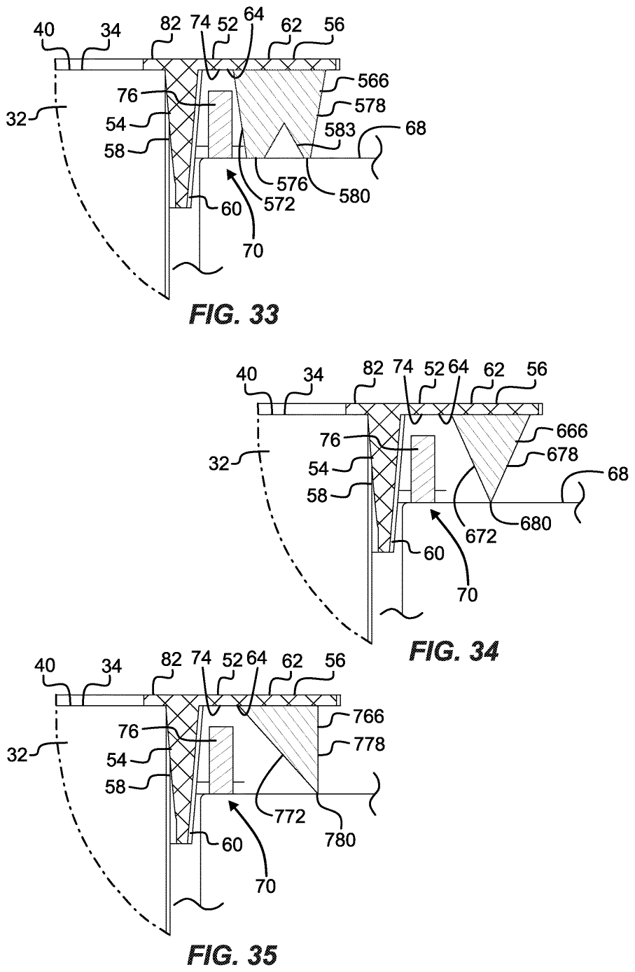

FIG. 33 shows the gasket member 566 as a seven-sided (i.e. heptagon) member. In the example shown, the gasket member 566 is an irregular heptagon. The gasket member 566 has a straight side 572 along the inner radial surface, and a straight side 578 along the outer radial surface. Against the tubesheet 68 and being angled relative to the side 572 is a first terminal end 576. Spaced from the first terminal end 576 is a second terminal end 580. Both terminal ends 576, 580 are against the tubesheet 66. The second terminal end 580 is angled relative to the outer radial side 578. Between the first terminal end 576 and second terminal end 580 are a pair of straight sides 582, 583 angled toward each other as they extend away from the respective terminal ends 576, 580, to meet at a point.

FIGS. 34 and 35 show triangle shaped gaskets 666, 766. FIG. 34 is an isosceles triangle gasket 666, with equal straight sides 672, 678, meeting at terminal end point 680. The terminal end point 680 is against the tubesheet 68. FIG. 35 a right angle shaped gasket 766, with straight sides 772, 778 meeting at terminal end point 780. The side 772 is shown as the hypotenuse.

In the example shown, the annular wall 54 has a length from the second axial surface 64 which is greater (longer) than a length of the gasket member 66 from the second axial surface 64.

In the embodiment shown, the gasket member 66 is only secured to the second axial surface 64 of the plate 56 and is free of attachment to any other portion of the gasket support 52. While various methods can be used, in one example the gasket member 66 is molded directly to the second axial surface 64. Other methods can include adhesive.

Still in reference to FIG. 5, the gasket support 52 may further include a lip 82. The lip 82 extends radially inwardly from the annular wall 54. The lip 82 is oriented on (against) a portion of the first flow face 40 of the media pack 32. In the example shown, the lip 82 is co-planar with the plate 56.

In accordance with principles of this disclosure, the filter element 30 has a deflector 84. The deflector 84 helps to prevent bruising of the filter media in the media pack 32, especially bruising that might result from reverse pulse cleaning of the media. The deflector 84 is secured to the first flow face 40. The first flow face 40 would normally be oriented as the downstream (or outflow) flow face 40, and the flow face that would receive air pulses to clean the media. The second flow face 42 is normally an upstream (or inflow) flow face 42.

The deflector 84 can be secured to the first flow face 40 in a region within 40%, or 30%, or 25%, or 10% of a length of the first flow face 40 from the first curved end 48. The deflector 84 is centered between the first side 44 and second side 46.

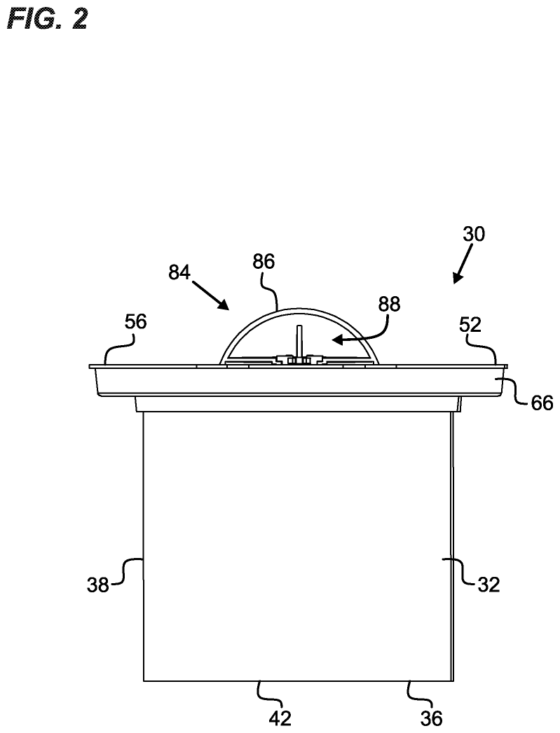

In reference now to FIG. 2, the deflector 84 includes a curved, solid surface 86 projecting from the first flow face 40. The curved surface 86 forms a quarter of a dome, defining an inner dome volume 88 between the surface 86 and the first flow face 40. The deflector 84 can be alternative shapes as well, such as polygon (regular including rectangular, pentagon, hexagon, octagon; or irregular polygons), pointed, chevron, lobed, or a combination of such shapes.

In accordance with principles of this disclosure, the filter element 30 has a bar 90 extending across the first flow face 40. In the example shown, the bar 90 is a center bar, extending from a center of the first curved end 48 to a center of the second curved end 50. The bar 90 may either continuously extend across the first flow face 40 as a single piece of material, or, as shown in FIGS. 1 and 6, extend across the first flow face 40 in two pieces 90a and 90b (FIG. 6), by having a small cut 91 at about a center of the bar 90. The cut 91 is helpful in reducing pressure on the bar 90, during airflow filtration therethrough.

In the example shown, the center bar 90 is an integral (same) part of the gasket support 52. The bar 90 extends from the lip 82 of the gasket support 52. Preferably, the bar 90 extends across the first flow face 40 bisecting the first flow face 40.

Preferably, the only structure over the first flow face 40 is the center bar 90 and deflector 84. The first flow face 40 is otherwise open and unobstructed.

In the example shown, the deflector 84 is connected to the center bar 90. Preferably, the deflector 84 is permanently (non-removably) attached or connected to the center bar 90.

In accordance with principles of this disclosure, the filter element 30 has a handle 92 secured to the media pack 32. The handle 92 is useable to hold, carry, or position the filter element 30 by a user. In this embodiment, the handle 92 is an integral part of the gasket support 52.

There can be many variations of the handle 92. In the example shown in FIGS. 1, 6, and 7, the handle 92 comprises a tab 94. The tab 94 extends radially from the plate 56 in a direction radially away from the media pack 32. The tab 94 is shown as being co-planar with the plate 56. While the tab 94 can be located in a variety of location, in the example shown, the tab 94 extends radially from the plate 56 at the end 99, next to the second curved end 50 of the media pack 32. The tab 94 can have a length that is between 20% and 60%; or between 30% and 50%; of a greatest length of the gasket support 52 between the opposite straight sides 96, 97.

### Example Media Configurations, Generally

Any type of filter media can be used as the media pack 32, as further described herein with relation to FIGS. 8-29.

The media can be of a variety of types and configurations, and can be made from using a variety of materials. For example, pleated media arrangements can be used in elements according to the principles of the present disclosure, as discussed below.

The principles are particularly well adapted for use in situations in which the media is quite deep in extension between the inlet and outlet ends of the element, but alternatives are possible. Also, the principles are often used in elements having relatively large cross-dimension sizes. With such arrangements, alternate media types to pleated media will often be desired.

In this section, examples of some media arrangements that are usable with the techniques described herein are provided. It will be understood, however, that a variety of alternate media types can be used. The choice of media type is generally one of preference for: availability; function in a given situation of application, ease of manufacturability, etc. and the choice is not necessarily specifically related to the overall function of selected ones of various filter element/air cleaner interaction features characterized herein.

Fluted filter media (media having media ridges) can be used to provide fluid filter constructions in a variety of manners. One well known manner is characterized herein as a z-filter construction. The term “z-filter construction” as used herein, is meant to include (but not be limited) a type of filter construction in which individual ones of corrugated, folded or otherwise formed filter flutes are used to define (typically in combination with facing media) sets of longitudinal, typically parallel, inlet and outlet filter flutes for fluid flow through the media. Some examples of z-filter media are provided in U.S. Pat. Nos. 5,820,646; 5,772,883; 5,902,364; 5,792,247; 5,895,574; 6,210,469; 6,190,432; 6,350,291; 6,179,890; 6,235,195; Des. 399,944; Des. 428,128; Des. 396,098; Des. 398,046; and, Des. 437,401; each of these cited references being incorporated herein by reference.

One type of z-filter media, utilizes two specific media components joined together, to form the media construction. The two components are: (1) a fluted (typically corrugated) media sheet or sheet section, and, (2) a facing media sheet or sheet section. The facing media sheet is typically non-corrugated, however it can be corrugated, for example perpendicularly to the flute direction as described in U.S. provisional 60/543,804, filed Feb. 11, 2004, and published as PCT WO 05/077487 on Aug. 25, 2005, incorporated herein by reference.

The fluted media section and facing media section can comprise separate materials between one another. However, they can also be sections of the single media sheet folded to bring the facing media material into appropriate juxtaposition with the fluted media portion of the media. For example, a single continuous sheet of media formed with alternating fluted and flat sections along the length of the media can be folded upon itself in zig-zag fashion to form a fluted media configuration.

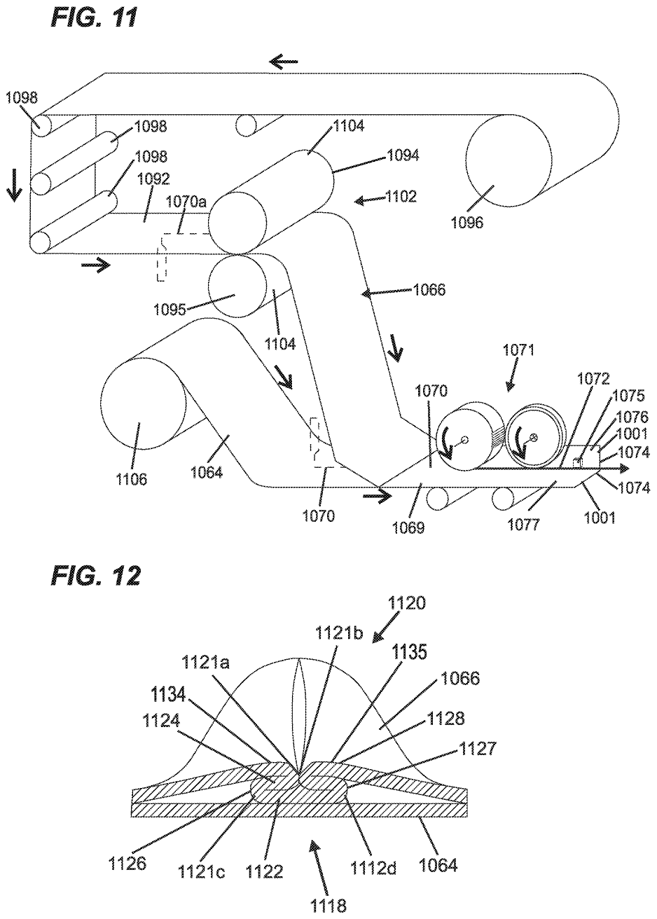

The fluted (typically corrugated) media sheet and the facing media sheet or sheet section together, are typically used to define media having parallel flutes. In some instances, the fluted sheet and facing sheet are separate and then secured together and are then coiled, as a media strip, to form a z-filter media construction. Such arrangements are described, for example, in U.S. Pat. Nos. 6,235,195 and 6,179,890, each of which is incorporated herein by reference. In certain other arrangements, some non-coiled sections or strips of fluted (typically corrugated) media secured to facing media, are stacked with one another, to create a filter construction. An example of this is described in FIG. 11 of U.S. Pat. No. 5,820,646, incorporated herein by reference.

Herein, strips of material comprising fluted sheet (sheet of media with ridges) secured to corrugated sheet, which are then assembled into stacks to form media packs, are sometimes referred to as “single facer strips,” “single faced strips,” or as “single facer” or “single faced” media. The terms and variants thereof, are meant to refer to a fact that one face, i.e., a single face, of the fluted (typically corrugated) sheet is faced by the facing sheet, in each strip.

Typically, coiling of a strip of the fluted sheet/facing sheet (i.e., single facer) combination around itself, to create a coiled media pack, is conducted with the facing sheet directed outwardly. Some techniques for coiling are described in U.S. provisional application 60/467,521, filed May 2, 2003 and PCT Application US 04/07927, filed Mar. 17, 2004, now published as WO 04/082795, each of which is incorporated herein by reference. The resulting coiled arrangement generally has, as the outer surface of the media pack, a portion of the facing sheet, as a result.

The term “corrugated” used herein to refer to structure in media, is often used to refer to a flute structure resulting from passing the media between two corrugation rollers, i.e., into a nip or bite between two rollers, each of which has surface features appropriate to cause corrugations in the resulting media. The term “corrugation” is however, not meant to be limited to such flutes, unless it is stated that they result from flutes that are by techniques involving passage of media into a bite between corrugation rollers. The term “corrugated” is meant to apply even if the media is further modified or deformed after corrugation, for example by the folding techniques described in PCT WO 04/007054, and published Jan. 22, 2004, incorporated herein by reference.

Corrugated media is a specific form of fluted media. Fluted media is media which has individual flutes or ridges (for example formed by corrugating or folding) extending thereacross.

Serviceable filter element or filter element configurations utilizing z-filter media are sometimes referred to as “straight through flow configurations” or by variants thereof. In general, in this context what is meant is that the serviceable filter elements or cartridges generally have an inlet flow end (or face) and an opposite exit flow end (or face), with flow entering and exiting the filter element in generally the same straight through direction. The term “serviceable” in this context is meant to refer to a media containing filter element that is periodically removed and replaced from a corresponding fluid (e.g. air) cleaner. In some instances, each of the inlet flow end (or face) and outlet flow end (or face) will be generally flat or planar, with the two parallel to one another. However, variations from this, for example non-planar faces, are possible.

A straight through flow configuration (especially for a coiled or stacked media pack) is, for example, in contrast to serviceable filter elements such as cylindrical pleated filter elements of the type shown in U.S. Pat. No. 6,039,778, incorporated herein by reference, in which the flow generally makes a substantial turn as its passes into and out of the media. That is, in a US. Pat. No. 6,039,778 filter, the flow enters the cylindrical filter element through a cylindrical side, and then turns to exit through an open end of the media (in forward-flow systems). In a typical reverse-flow system, the flow enters the serviceable cylindrical element through an open end of the media and then turns to exit through a side of the cylindrical filter media. An example of such a reverse-flow system is shown in U.S. Pat. No. 5,613,992, incorporated by reference herein.

The term “z-filter media construction” and variants thereof as used herein, without more, is meant to include, but not necessarily be limited to, any or all of: a web of corrugated or otherwise fluted media (media having media ridges) secured adjacent to (facing) media, whether the sheets are separate or part of a single web, with appropriate sealing (closure) to allow for definition of inlet and outlet flutes; and/or a media pack constructed or formed from such media into a three dimensional network of inlet and outlet flutes; and/or, a filter element or construction including such a media pack.

In FIG. 8, an example of media 1001 useable in z-filter media construction is shown. The media 1 is formed from a fluted, in this instance corrugated, sheet 1003 and a facing sheet 1004. A construction such as media 1001 is referred to herein as a single facer or single faced strip.

Sometimes, the corrugated fluted or ridged sheet 1003, FIG. 8, is of a type generally characterized herein as having a regular, curved, wave pattern of flutes, ridges or corrugations 1007. The term “wave pattern” in this context, is meant to refer to a flute, ridge or corrugated pattern of alternating troughs 1007b and ridges 1007a. The term “regular” in this context is meant to refer to the fact that the pairs of troughs and ridges (1007b, 1007a) alternate with generally the same repeating corrugation (flute or ridge) shape and size. (Also, typically in a regular configuration each trough 1007b is substantially an inverse ridge for each ridge 1007a.) The term “regular” is thus meant to indicate that the corrugation (or flute) pattern comprises troughs (inverted ridges) and ridges with each pair (comprising an adjacent trough and ridge) repeating, without substantial modification in size and shape of the corrugations along at least 70% of the length of the flutes. The term “substantial” in this context, refers to a modification resulting from a change in the process or form used to create the corrugated or fluted sheet, as opposed to minor variations from the fact that the media sheet 3 is flexible. With respect to the characterization of a repeating pattern, it is not meant that in any given filter construction, an equal number of ridges and troughs is necessarily present. The media 1001 could be terminated, for example, between a pair comprising a ridge and a trough, or partially along a pair comprising a ridge and a trough. (For example, in FIG. 8 the media 1001 depicted in fragmentary has eight complete ridges 1007a and seven complete troughs 1007b.) Also, the opposite flute ends (ends of the troughs and ridges) may vary from one another. Such variations in ends are disregarded in these definitions, unless specifically stated. That is, variations in the ends of flutes are intended to be covered by the above definitions.

In the context of the characterization of a “curved” wave pattern of corrugations, in certain instances the corrugation pattern is not the result of a folded or creased shape provided to the media, but rather the apex 1007a of each ridge and the bottom 7b of each trough is formed along a radiused curve. A typical radius for such z-filter media would be at least 0.25 mm and typically would be not more than 3 mm.

An additional characteristic of the particular regular, curved, wave pattern depicted in FIG. 8, for the corrugated sheet 1003, is that at approximately a midpoint 1030 between each trough and each adjacent ridge, along most of the length of the flutes 1007, is located a transition region where the curvature inverts. For example, viewing back side or face 1003a, FIG. 8, trough 1007b is a concave region, and ridge 1007a is a convex region. Of course when viewed toward front side or face 1003b, trough 1007b of side 1003a forms a ridge; and, ridge 1007a of face 1003a, forms a trough. (In some instances, region 1030 can be a straight segment, instead of a point, with curvature inverting at ends of the segment 1030.)

A characteristic of the particular regular, wave pattern fluted (in this instance corrugated) sheet 1003 shown in FIG. 8, is that the individual corrugations, ridges or flutes are generally straight, although alternatives are possible. By “straight” in this context, it is meant that through at least 70%, typically at least 80% of the length, the ridges 1007a and troughs (or inverted ridges) 1007b do not change substantially in cross-section. The term “straight” in reference to corrugation pattern shown in FIG. 8, in part distinguishes the pattern from the tapered flutes of corrugated media described in FIG. 1 of WO 97/40918 and PCT Publication WO 03/47722, published Jun. 12, 2003, incorporated herein by reference. The tapered flutes of FIG. 1 of WO 97/40918, for example, would be a curved wave pattern, but not a “regular” pattern, or a pattern of straight flutes, as the terms are used herein.

Referring to the present FIG. 8 and as referenced above, the media 1001 has first and second opposite edges 1008 and 1009. When the media 1001 is formed into a media pack, in general edge 1009 will form an inlet end or face for the media pack and edge 1008 an outlet end or face, although an opposite orientation is possible.

In the example depicted, the various flutes 1007 extend completely between the opposite edges 1008, 1009, but alternatives are possible. For example, they can extend to a location adjacent or near the edges, but not completely therethrough. Also, they can be stopped and started partway through the media, as for example in the media of US 2014/0208705 A1, incorporated herein by reference.

When the media is as depicted in FIG. 8, adjacent edge 1008 can provided a sealant bead 1010, sealing the corrugated sheet 3 and the facing sheet 1004 together. Bead 1010 will sometimes be referred to as a “single facer” or “single face” bead, or by variants, since it is a bead between the corrugated sheet 1003 and facing sheet 1004, which forms the single facer (single faced) media strip 1001. Sealant bead 1010 seals closed individual flutes 1011 adjacent edge 1008, to passage of air therefrom (or thereto in an opposite flow).

In the media depicted in FIG. 8, adjacent edge 1009 is provided seal bead 1014. Seal bead 1014 generally closes flutes 1015 to passage of unfiltered fluid therefrom (or flow therein in an opposite flow), adjacent edge 1009. Bead 1014 would typically be applied as media 1001 is configured into a media pack. If the media pack is made from a stack of strips 1001, bead 1014 will form a seal between a backside 1017 of facing sheet 1004, and side 1018 of the next adjacent corrugated sheet 1003. When the media 1001 is cut in strips and stacked, instead of coiled, bead 1014 is referenced as a “stacking bead.” (When bead 1014 is used in a coiled arrangement formed from a long strip of media 1001, it may be referenced as a “winding bead.”).

In alternate types of through-flow media, seal material can be located differently, and added sealant or adhesive can even be avoided. For example, in some instances, the media can be folded to form an end or edge seam; or, the media can be sealed closed by alternate techniques such as ultrasound application, etc. Further, even when sealant material is used, it need not be adjacent opposite ends.

Referring to FIG. 8, once the filter media 1001 is incorporated into a media pack, for example by stacking or coiling, it can be operated as follows. First, air in the direction of arrows 1012, would enter open flutes 1011 adjacent end 1009. Due to the closure at end 1008, by bead 1010, the air would pass through the filter media 1001, for example as shown by arrows 1013. It could then exit the media or media pack, by passage through open ends 1015a of the flutes 1015, adjacent end 1008 of the media pack. Of course operation could be conducted with air flow in the opposite direction.

For the particular arrangement shown herein in FIG. 1001, the parallel corrugations 1007a, 1007b are generally straight completely across the media, from edge 1008 to edge 1009. Straight flutes, ridges or corrugations can be deformed or folded at selected locations, especially at ends. Modifications at flute ends for closure are generally disregarded in the above definitions of “regular,” “curved” and “wave pattern.”

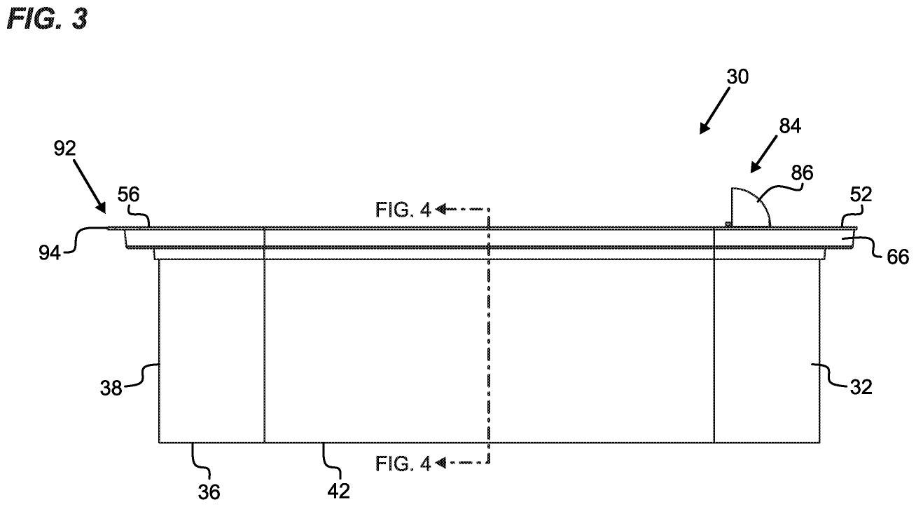

Z-filter constructions which do not utilize straight, regular curved wave pattern corrugation shapes are known. For example in Yamada et al. U.S. Pat. No. 5,562,825 corrugation patterns which utilize somewhat semicircular (in cross section) inlet flutes adjacent narrow V-shaped (with curved sides) exit flutes are shown (see FIGS. 1 and 3, of U.S. Pat. No. 5,562,825). In Matsumoto, et al. U.S. 5,049,326 circular (in cross-section) or tubular flutes defined by one sheet having half tubes attached to another sheet having half tubes, with flat regions between the resulting parallel, straight, flutes are shown, see FIG. 2 of Matsumoto '326. In Ishii, et al. U.S. Pat. No. 4,925,561 (FIG. 1) flutes folded to have a rectangular cross section are shown, in which the flutes taper along their lengths. In WO 97/40918 (FIG. 1), flutes or parallel corrugations which have a curved, wave patterns (from adjacent curved convex and concave troughs) but which taper along their lengths (and thus are not straight) are shown. Also, in WO 97/40918 flutes which have curved wave patterns, but with different sized ridges and troughs, are shown. Also, flutes, which are modified in shape to include various ridges, are known.

In general, the filter media is a relatively flexible material, typically a non-woven fibrous material (of cellulose fibers, synthetic fibers or both) often including a resin therein, sometimes treated with additional materials. Thus, it can be conformed or configured into the various corrugated patterns, without unacceptable media damage. Also, it can be readily coiled or otherwise configured for use, again without unacceptable media damage. Of course, it must be of a nature such that it will maintain the required corrugated configuration, during use.

Typically, in the corrugation process, an inelastic deformation is caused to the media. This prevents the media from returning to its original shape. However, once the tension is released the flute or corrugations will tend to spring back, recovering only a portion of the stretch and bending that has occurred. The facing media sheet is sometimes tacked to the fluted media sheet, to inhibit this spring back in the corrugated sheet. Such tacking is shown at 1020.

Also, typically, the media contains a resin. During the corrugation process, the media can be heated to above the glass transition point of the resin. When the resin then cools, it will help to maintain the fluted shapes.

The media of the corrugated (fluted) sheet 1003 facing sheet 1004 or both, can be provided with a fine fiber material on one or both sides thereof, for example in accord with U.S. Pat. No. 6,673,136, incorporated herein by reference. In some instances, when such fine fiber material is used, it may be desirable to provide the fine fiber on the upstream side of the material and inside the flutes. When this occurs, air flow, during filtering, will typically be into the edge comprising the stacking bead.

An issue with respect to z-filter constructions relates to closing of the individual flute ends. Although alternatives are possible, typically a sealant or adhesive is provided, to accomplish the closure. As is apparent from the discussion above, in typical z-filter media especially that which uses straight flutes as opposed to tapered flutes and sealant for flute seals, large sealant surface areas (and volume) at both the upstream end and the downstream end are needed. High quality seals at these locations are important to proper operation of the media structure that results. The high sealant volume and area, creates issues with respect to this.

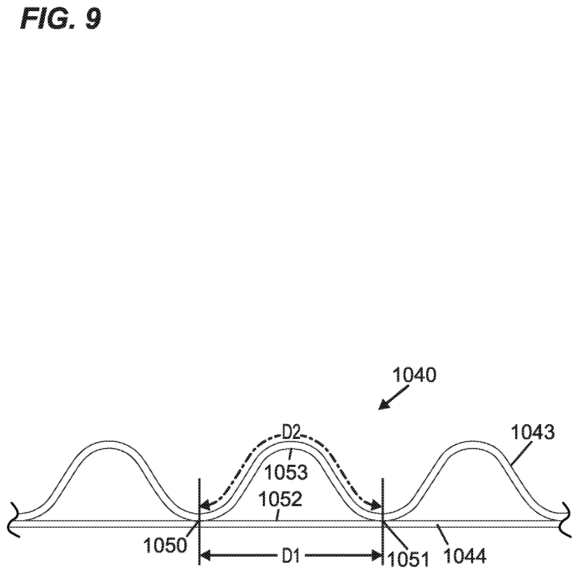

Attention is now directed to FIG. 9, in which z-filter media; i.e., a z-filter media construction 1040, utilizing a regular, curved, wave pattern corrugated sheet 1043, and a non-corrugated flat sheet 1044, i.e., a single facer strip is schematically depicted. The distance D1, between points 1050 and 1051, defines the extension of flat media 1044 in region 1052 underneath a given corrugated flute 1053. The length D2 of the arcuate media for the corrugated flute 1053, over the same distance D1 is of course larger than D1, due to the shape of the corrugated flute 1053. For a typical regular shaped media used in fluted filter applications, the linear length D2 of the media 1053 between points 1050 and 1051 will often be at least 1.2 times D1. Typically, D2 would be within a range of 1.2-2.0 times D1, inclusive. One particularly convenient arrangement for air filters has a configuration in which D2 is about 1.25-1.35×D1. Such media has, for example, been used commercially in Donaldson Powercore™ Z-filter arrangements. Another potentially convenient size would be one in which D2 is about 1.4-1.6 times D1. Herein the ratio D2/D1 will sometimes be characterized as the flute/flat ratio or media draw for the corrugated media.

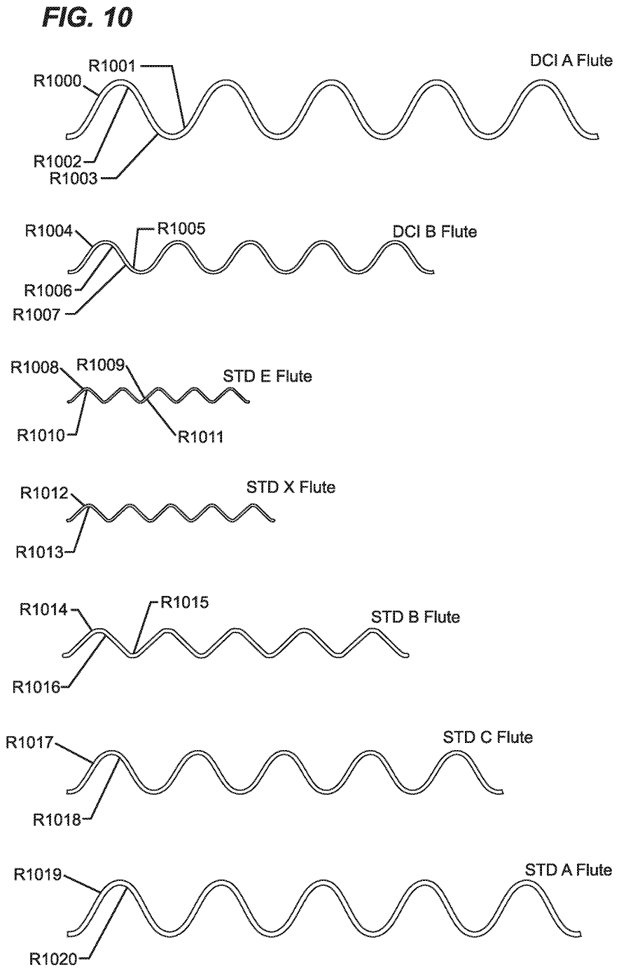

In the corrugated cardboard industry, various standard flutes have been defined. For example the standard E flute, standard X flute, standard B flute, standard C flute and standard A flute. FIG. 10, attached, in combination with Table A below provides definitions of these flutes.

Donaldson Company, Inc., (DCI) the assignee of the present disclosure, has used variations of the standard A and standard B flutes, in a variety of z-filter arrangements. These flutes are also defined in Table A and FIG. 10.

TABLE A
(Flute definitions for FIG. 10)

DCI A Flute: Flute/flat = 1.52:1; The Radii (R) are as follows:
R1000 = .0675 inch (1.715 mm); R1001 = .0581 inch (1.476 mm);
R1002 = .0575 inch (1.461 mm); R1003 = .0681 inch (1.730 mm);
DCI B Flute: Flute/flat = 1.32:1; The Radii (R) are as follows:
R1004 = .0600 inch (1.524 mm); R1005 = .0520 inch (1.321 mm);
R1006 = .0500 inch (1.270 mm); R1007 = .0620 inch (1.575 mm);
Std. E Flute: Flute/flat = 1.24:1; The Radii (R) are as follows:
R1008 = .0200 inch (.508 mm); R1009 = .0300 inch (.762 mm);
R1010 = .0100 inch (.254 mm); R1011 = .0400 inch (1.016 mm);
Std. X Flute: Flute/flat = 1.29:1; The Radii (R) are as follows:
R1012 = .0250 inch (.635 mm); R1013 = .0150 inch (.381 mm);
Std. B Flute: Flute/flat = 1.29:1; The Radii (R) are as follows:
R1014 = .0410 inch (1.041 mm); R1015 = .0310 inch (.7874 mm);
R1016 = .0310 inch (.7874 mm);
Std. C Flute: Flute/flat = 1.46:1; The Radii (R) are as follows:
R1017 = .0720 inch (1.829 mm); R1018 = .0620 inch (1.575 mm);
Std. A Flute: Flute/flat = 1.53:1; The Radii (R) are as follows:
R1019 = .0720 inch (1.829 mm); R1020 = .0620 inch (1.575 mm).

Of course other, standard, flutes definitions from the corrugated box industry are known.

In general, standard flute configurations from the corrugated box industry can be used to define corrugation shapes or approximate corrugation shapes for corrugated media. Comparisons above between the DCI A flute and DCI B flute, and the corrugation industry standard A and standard B flutes, indicate some convenient variations.

It is noted that alternative flute definitions such as those characterized in U.S. Ser. No. 12/215,718, filed Jun. 26, 2008; and published as US 2009/0127211; US Ser. No. 12/012,785, filed Feb. 4, 2008 and published as US 2008/0282890; and/or US Ser. No. 12/537,069 published as US 2010/0032365 can be used, with air cleaner features as characterized herein below. The complete disclosures of each of US 2009/0127211, US 2008/0282890 and US 2010/0032365 are incorporated herein by reference.

Another media variation comprising fluted media with facing media secured thereto, can be used in arrangements according to the present disclosure, in either a stacked or coiled form, is described in US 2014/0208705 A1, owned by Baldwin Filters, Inc., published Jul. 31, 2014, and incorporated herein by reference.

### Manufacture of Media Pack Configurations

In FIG. 11, one example of a manufacturing process for making a media strip (single facer) corresponding to strip 1001, FIG. 8 is shown. In general, facing sheet 1064 and the fluted (corrugated) sheet 1066 having flutes 1068 are brought together to form a media web 1069, with an adhesive bead located therebetween at 1070. The adhesive bead 1070 will form a single facer bead 1010, FIG. 8. An optional darting process occurs at station 1071 to form center darted section 1072 located mid-web. The z-filter media or Z-media strip 1074 can be cut or slit at 1075 along the bead 1070 to create two pieces or strips 1076, 1077 of z-filter media 1074, each of which has an edge with a strip of sealant (single facer bead) extending between the corrugating and facing sheet. Of course, if the optional darting process is used, the edge with a strip of sealant (single facer bead) would also have a set of flutes darted at this location.

Techniques for conducting a process as characterized with respect to FIG. 11 are described in PCT WO 04/007054, published Jan. 22, 2004 incorporated herein by reference.

Still in reference to FIG. 11, before the z-filter media 1074 is put through the darting station 1071 and eventually slit at 1075, it must be formed. In the schematic shown in FIG. 1004, this is done by passing a sheet of filter media 1092 through a pair of corrugation rollers 1094, 1095. In the schematic shown in FIG. 11, the sheet of filter media 1092 is unrolled from a roll 1096, wound around tension rollers 1098, and then passed through a nip or bite 1102 between the corrugation rollers 1094, 1095. The corrugation rollers 1094, 1095 have teeth 1104 that will give the general desired shape of the corrugations after the flat sheet 1092 passes through the nip 1102. After passing through the nip 1102, the sheet 1092 becomes corrugated across the machine direction and is referenced at 1066 as the corrugated sheet. The corrugated sheet 1066 is then secured to facing sheet 1064. (The corrugation process may involve heating the media, in some instances.)

Still in reference to FIG. 11, the process also shows the facing sheet 1064 being routed to the darting process station 1071. The facing sheet 1064 is depicted as being stored on a roll 1106 and then directed to the corrugated sheet 1066 to form the Z-media 1074. The corrugated sheet 1066 and the facing sheet 1064 would typically be secured together by adhesive or by other means (for example by sonic welding).

Referring to FIG. 11, an adhesive line 1070 is shown used to secure corrugated sheet 1066 and facing sheet 1064 together, as the sealant bead. Alternatively, the sealant bead for forming the facing bead could be applied as shown as 1070a. If the sealant is applied at 1070a, it may be desirable to put a gap in the corrugation roller 1095, and possibly in both corrugation rollers 1094, 1095, to accommodate the bead 1070a.

Of course the equipment of FIG. 11 can be modified to provide for the tack beads 1020, FIG. 8, if desired.

The type of corrugation provided to the corrugated media is a matter of choice, and will be dictated by the corrugation or corrugation teeth of the corrugation rollers 1094, 1095. One useful corrugation pattern will be a regular curved wave pattern corrugation, of straight flutes or ridges, as defined herein above. A typical regular curved wave pattern used, would be one in which the distance D2, as defined above, in a corrugated pattern is at least 1.2 times the distance D1 as defined above. In example applications, typically D2=1.25-1.35×D1, although alternatives are possible. In some instances the techniques may be applied with curved wave patterns that are not “regular,” including, for example, ones that do not use straight flutes. Also, variations from the curved wave patterns shown, are possible.

As described, the process shown in FIG. 11 can be used to create the center darted section 1072. FIG. 12 shows, in cross-section, one of the flutes 1068 after darting and slitting.

A fold arrangement 1118 can be seen to form a darted flute 1120 with four creases 1121a, 1121b, 1121c, 1121d. The fold arrangement 1118 includes a flat first layer or portion 1122 that is secured to the facing sheet 1064. A second layer or portion 1124 is shown pressed against the first layer or portion 1122. The second layer or portion 1124 is preferably formed from folding opposite outer ends 1126, 1127 of the first layer or portion 1122.

Still referring to FIG. 12, two of the folds or creases 1121a, 1121b will generally be referred to herein as “upper, inwardly directed” folds or creases. The term “upper” in this context is meant to indicate that the creases lie on an upper portion of the entire fold 1120, when the fold 1120 is viewed in the orientation of FIG. 12. The term “inwardly directed” is meant to refer to the fact that the fold line or crease line of each crease 1121a, 1121b, is directed toward the other.

In FIG. 12, creases 1121c, 1121d, will generally be referred to herein as “lower, outwardly directed” creases. The term “lower” in this context refers to the fact that the creases 1121c, 1121d are not located on the top as are creases 1121a, 1121b, in the orientation of FIG. 12. The term “outwardly directed” is meant to indicate that the fold lines of the creases 1121c, 1121d are directed away from one another.

The terms “upper” and “lower” as used in this context are meant specifically to refer to the fold 1120, when viewed from the orientation of FIG. 12. That is, they are not meant to be otherwise indicative of direction when the fold 1120 is oriented in an actual product for use.

Based upon these characterizations and review of FIG. 12, it can be seen that a regular fold arrangement 1118 according to FIG. 5 in this disclosure is one which includes at least two “upper, inwardly directed, creases.” These inwardly directed creases are unique and help provide an overall arrangement in which the folding does not cause a significant encroachment on adjacent flutes.

A third layer or portion 1128 can also be seen pressed against the second layer or portion 1124. The third layer or portion 1128 is formed by folding from opposite inner ends 1130, 1131 of the third layer 1128.

Another way of viewing the fold arrangement 1118 is in reference to the geometry of alternating ridges and troughs of the corrugated sheet 1066. The first layer or portion 1122 is formed from an inverted ridge. The second layer or portion 1124 corresponds to a double peak (after inverting the ridge) that is folded toward, and in preferred arrangements, folded against the inverted ridge.

Techniques for providing the optional dart described in connection with FIG. 12, in a preferred manner, are described in PCT WO 04/007054, incorporated herein by reference. Techniques for coiling the media, with application of the winding bead, are described in PCT application US 04/07927, filed Mar. 17, 2004 and published as WO 04/082795 and incorporated herein by reference.

Alternate approaches to darting the fluted ends closed are possible. Such approaches can involve, for example: darting which is not centered in each flute; and, rolling, pressing or folding over the various flutes. In general, darting involves folding or otherwise manipulating media adjacent to fluted end, to accomplish a compressed, closed, state.

Techniques described herein are particularly well adapted for use in media packs that result from a step of coiling a single sheet comprising a corrugated sheet/facing sheet combination, i.e., a “single facer” strip. However, they can also be made into stacked arrangements.

Coiled media or media pack arrangements can be provided with a variety of peripheral perimeter definitions. In this context the term “peripheral, perimeter definition” and variants thereof, is meant to refer to the outside perimeter shape defined, looking at either the inlet end or the outlet end of the media or media pack. Typical shapes are circular as described in PCT WO 04/007054. Other useable shapes are obround, some examples of obround being oval shape. In general oval shapes have opposite curved ends attached by a pair of opposite sides. In some oval shapes, the opposite sides are also curved. In other oval shapes, sometimes called racetrack shapes, the opposite sides are generally straight. Racetrack shapes are described for example in PCT WO 04/007054, and PCT application US 04/07927, published as WO 04/082795, each of which is incorporated herein by reference.

Another way of describing the peripheral or perimeter shape is by defining the perimeter resulting from taking a cross-section through the media pack in a direction orthogonal to the winding access of the coil.

Opposite flow ends or flow faces of the media or media pack can be provided with a variety of different definitions. In many arrangements, the ends or end faces are generally flat (planer) and perpendicular to one another. In other arrangements, one or both of the end faces include tapered, for example, stepped, portions which can either be defined to project axially outwardly from an axial end of the side wall of the media pack; or, to project axially inwardly from an end of the side wall of the media pack.

The flute seals (for example from the single facer bead, winding bead or stacking bead) can be formed from a variety of materials. In various ones of the cited and incorporated references, hot melt or polyurethane seals are described as possible for various applications.

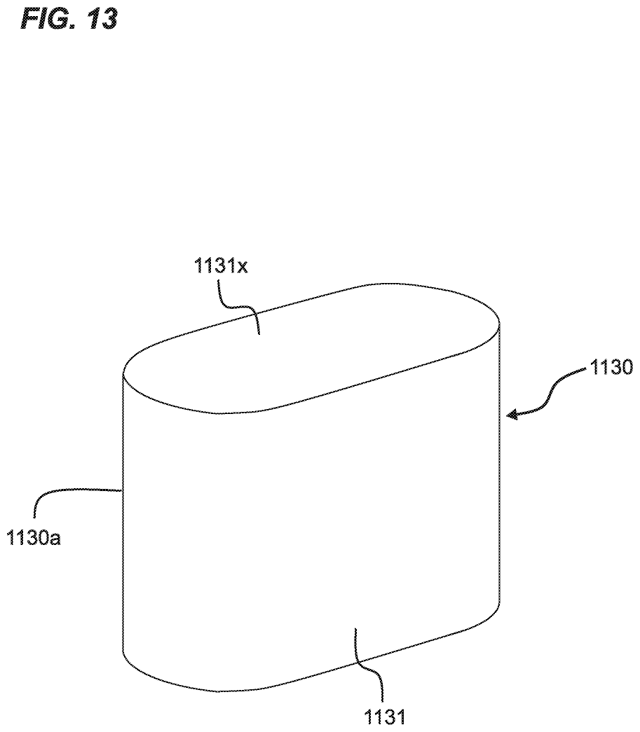

In FIG. 13, a coiled media pack (or coiled media) 1130 constructed by coiling a single strip of single faced media is depicted, generally. The particular coiled media pack depicted is an oval media pack 1130a, specifically a racetrack shaped media pack 1131. The tail end of the media, at the outside of the media pack 1130 is shown at 1131x. It will be typical to terminate that tail end along straight section of the media pack 1130 for convenience and sealing. Typically, a hot melt seal bead or seal bead is positioned along that tail end to ensure sealing. In the media pack 130, the opposite flow (end) faces are designated at 1132, 1133. One would be an inlet flow end or face, the other an outlet flow end or face.

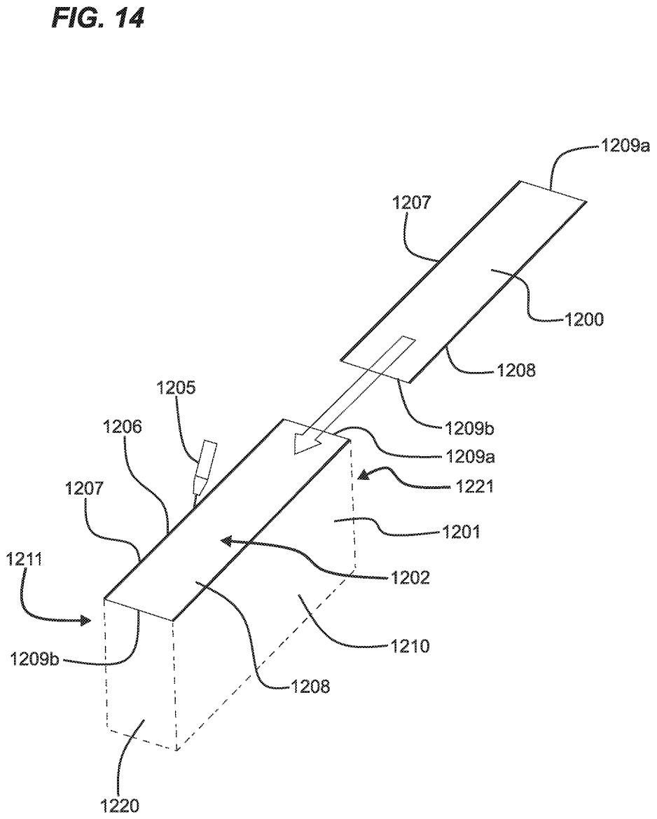

In FIG. 14, there is (schematically) shown a step of forming stacked z-filter media (or media pack) from strips of z-filter media, each strip being a fluted sheet secured to a facing sheet. Referring to FIG. 13, single facer strip 1200 is being shown added to a stack 1201 of strips 1202 analogous to strip 1200. Strip 1200 can be cut from either of strips 176, 177, FIG. 11. At 1205, FIG. 13, application of a stacking bead 1206 is shown, between each layer corresponding to a strip 1200, 1202 at an opposite edge from the single facer bead or seal. (Stacking can also be done with each layer being added to the bottom of the stack, as opposed to the top.)

Referring to FIG. 14, each strip 1200, 1202 has front and rear edges 1207, 208 and opposite side edges 1209a, 1209b. Inlet and outlet flutes of the corrugated sheet/facing sheet combination comprising each strip 1200, 1202 generally extend between the front and rear edges 1207, 1208, and parallel to side edges 1209a, 1209b.

Still referring to FIG. 14, in the media or media pack 1201 being formed, opposite flow faces are indicated at 1210, 1211. The selection of which one of faces 1210, 1211 is the inlet end face and which is the outlet end face, during filtering, is a matter of choice. In some instances the stacking bead 206 is positioned adjacent the upstream or inlet face 1211; in others the opposite is true. The flow faces 210, 211, extend between opposite side faces 1220, 1221.

The stacked media configuration or pack 1201 shown being formed in FIG. 14, is sometimes referred to herein as a “blocked” stacked media pack. The term “blocked” in this context, is an indication that the arrangement is formed to a rectangular block in which all faces are 90° relative to all adjoining wall faces. For example, in some instances the stack can be created with each strip 200 being slightly offset from alignment with an adjacent strip, to create a parallelogram or slanted block shape, with the inlet face and outlet face parallel to one another, but not perpendicular to upper and bottom surfaces.

In some instances, the media or media pack will be referenced as having a parallelogram shape in any cross-section, meaning that any two opposite side faces extend generally parallel to one another.

It is noted that a blocked, stacked arrangement corresponding to FIG. 14 is described in the prior art of U.S. Pat. No. 5,820,646, incorporated herein by reference. It is also noted that stacked arrangements are described in U.S. Pat. Nos. 5,772,883; 5,792,247; U.S. Provisional 60/457,255 filed Mar. 25, 2003; and U.S. Ser. No. 10/731,564 filed Dec. 8, 2003 and published as 2004/0187689. Each of these latter references is incorporated herein by reference. It is noted that a stacked arrangement shown in U.S. Ser. No. 10/731,504, published as 2005/0130508 is a slanted stacked arrangement.

It is also noted that, in some instances, more than one stack can be incorporated into a single media pack. Also, in some instances, the stack can be generated with one or more flow faces that have a recess therein, for example, as shown in U.S. Pat. No. 7,625,419 incorporated herein by reference.

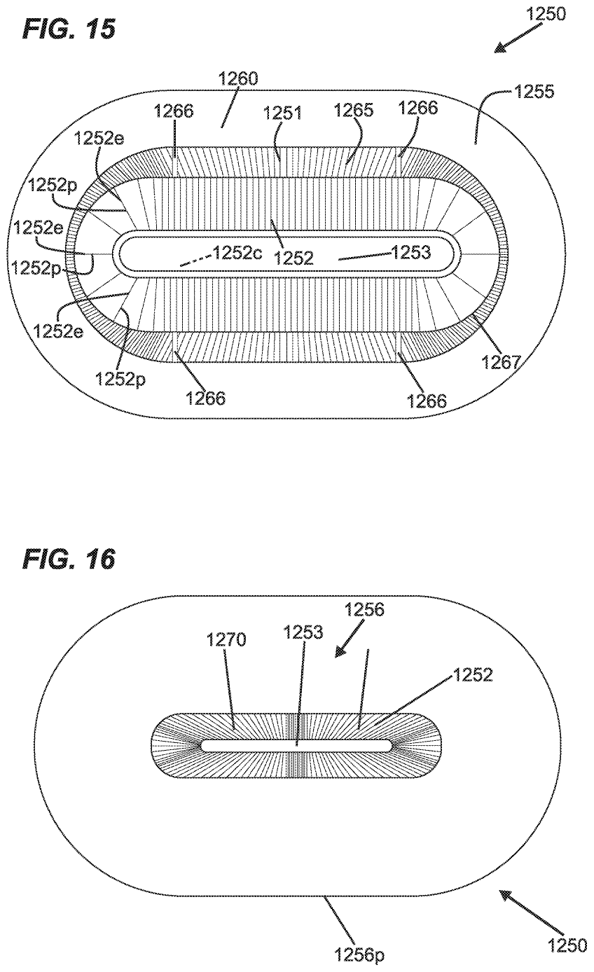

### Selected Media or Media Pack Arrangements Comprising Multiple Spaced Coils of Fluted Media; FIGS. 15-17

Alternate types of media arrangements or packs that involve flutes between opposite ends extending between can be used with selected principles according to the present disclosure. An example of such alternate media arrangement or pack is depicted in FIGS. 15-17. The media of FIGS. 15-17 is analogous to one depicted and described in DE 20 2008 017 059 U1; and as can sometimes found in arrangements available under the mark “IQORON” from Mann & Hummel.

Referring to FIG. 15, the media or media pack is indicated generally at 1250. The media or media pack 1250 comprises a first outer pleated (ridged) media loop 1251 and a second, inner, pleated (ridged) media loop 1252, each with pleat tips (or ridges) extending between opposite flow ends. The view of FIG. 15 is toward a media pack (flow) end 1255. The end 1255 depicted, can be an inlet (flow) end or an outlet (flow) end, depending on selected flow direction. For many arrangements using principles characterized having the media pack 1250 would be configured in a filter element such that end 1255 is an inlet flow end.

Still referring to FIG. 15, the outer pleated (ridged) media loop 1251 is configured in an oval shape, though alternatives are possible. At 1260, a pleat end closure, for example molded in place, is depicted closing ends of the pleats or ridges 1251 at media pack end 1255.

Pleats, or ridges 1252 (and the related pleat tips) are positioned surrounded by and spaced from loop 1251, and thus pleated media loop 1252 is also depicted in a somewhat oval configuration. In this instance, ends 1252e of individual pleats or ridges 1252p in a loop 1252 are sealed closed. Also, loop 1252 surrounds the center 1252c that is closed by a center strip 1253 of material, typically molded-in-place.

During filtering, when end 1255 is an inlet flow end, air enters gap 1265 between the two loops of media 1251, 1252. The air then flows either through loop 1251 or loop 1252, as it moves through the media pack 250, with filtering.

In the example depicted, loop 1251 is configured slanting inwardly toward loop 1252, in extension away from end 1255. Also spacers 1266 are shown supporting a centering ring 1267 that surrounds an end of the loop 1252, for structural integrity.

In FIG. 16, an end 1256 of the element 1250, opposite end 1255 is viewable. Here, an interior of loop 1252 can be seen, surrounding an open gas flow region 1270. When air is directed through element 1250 in a general direction toward end 1256 and away from end 1255, the portion of the air that passes through loop 1252 will enter central region 1270 and exit therefrom at end 1256. Of course air that has entered media loop 1251, FIG. 15, during filtering would generally pass around (over) an outer perimeter 1256p of end 1256.

In FIG. 17 a schematic cross sectional view of element 1250 is provided. Selected identified and described features are indicated by like reference numerals

It will be understood from a review of FIGS. 15-17, the above description, that the element 1250 described, is generally a element which has media tips extending in a longitudinal direction between opposite flow ends 1255, 1256.

In the arrangement of FIGS. 15-17, the media pack 1250 is depicted with an oval, in particular racetrack, shaped perimeter. It is depicted in this manner, since the air filter elements in many examples below also have an oval or racetrack shaped configuration. However, the principles can be embodied in a variety of alternate peripheral shapes.

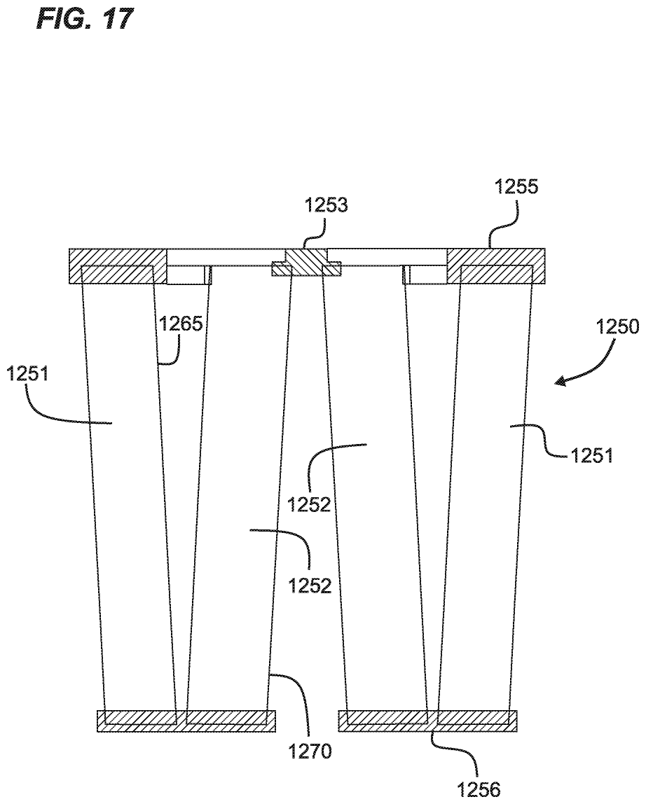

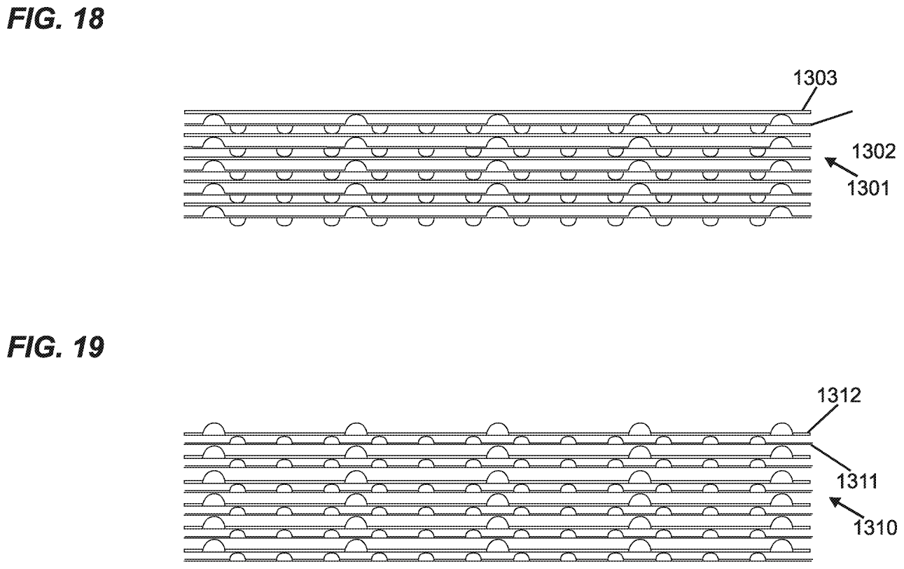

### Other Media Variations, FIGS. 18-23

Herein, in FIGS. 18-23, some schematic, fragmentary, cross-sectional views are provided of still further alternate variations of media types that can be used in selected applications of the principles characterized herein. Certain examples are described in U.S. Ser. No. 62/077,749, filed Nov. 10, 2014 and owned by the Assignee of the present disclosure, Donaldson Company, Inc. In general, each of the arrangements of FIGS. 9-12 represents a media type that can be stacked or coiled into an arrangement that has opposite inlet and outlet flow ends (or faces), with straight through flow.

In FIG. 18, an example media arrangement 1301 from U.S. Ser. No. 62/077,749 (2658) is depicted, in which an embossed sheet 1302 is secured to a non-embossed sheet 1303, then stacked and coiled into a media pack, with seals along opposite edges of the type previously described for FIG. 8 herein.

In FIG. 19, an alternate example media pack 1310 from U.S. Ser. No. 62/077,749 is depicted, in which a first embossed sheet 1311 is secured to a second embossed sheet 1312 and then formed into a stacked or coiled media pack arrangement, having edge seals generally in accord with FIG. 8 herein.

Edge seals can be conducted in either the upstream end or the downstream end, or in some instances both. Especially when the media is likely to encounter chemical material during filtering, it may be desirable to avoid a typical adhesive or sealant.

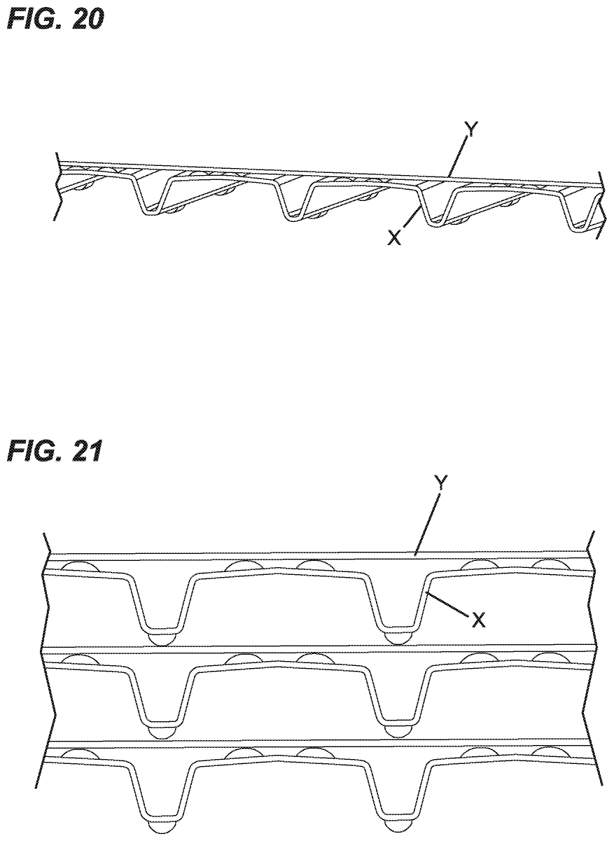

In FIG. 20, a cross-section is depicted in which the fluted sheet X has various embossments on it for engagement with the facing sheet Y. Again these can be separate, or sections of the same media sheet.

In FIG. 21, a schematic depiction of such an arrangement between the fluted sheet X and facing sheet Y is also shown.

In FIG. 22, a still further variation of such a principle is shown between a fluted sheet X and a facing sheet Y. These are meant to help understand how a wide variety of approaches are possible.

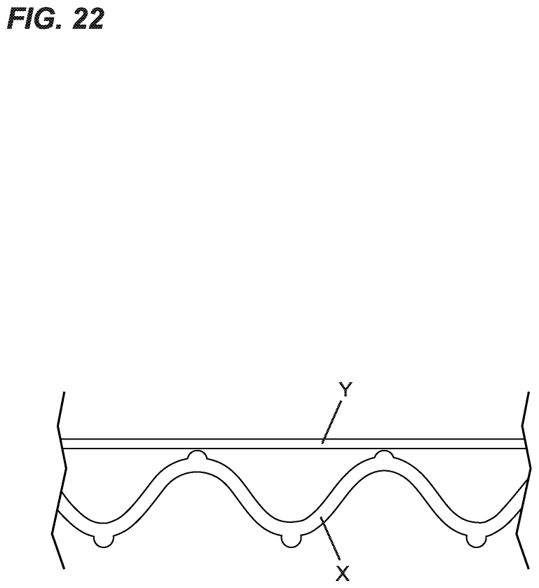

In FIG. 23, still another possible variation in fluted sheet X and facing sheet Y is shown.

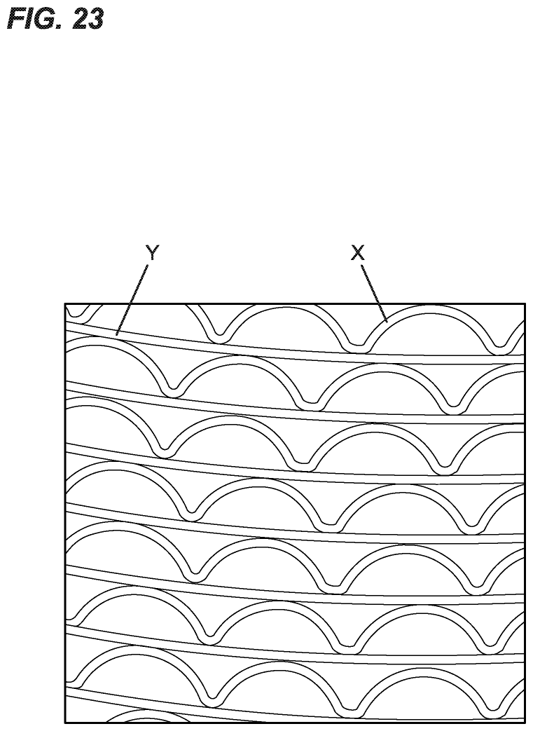

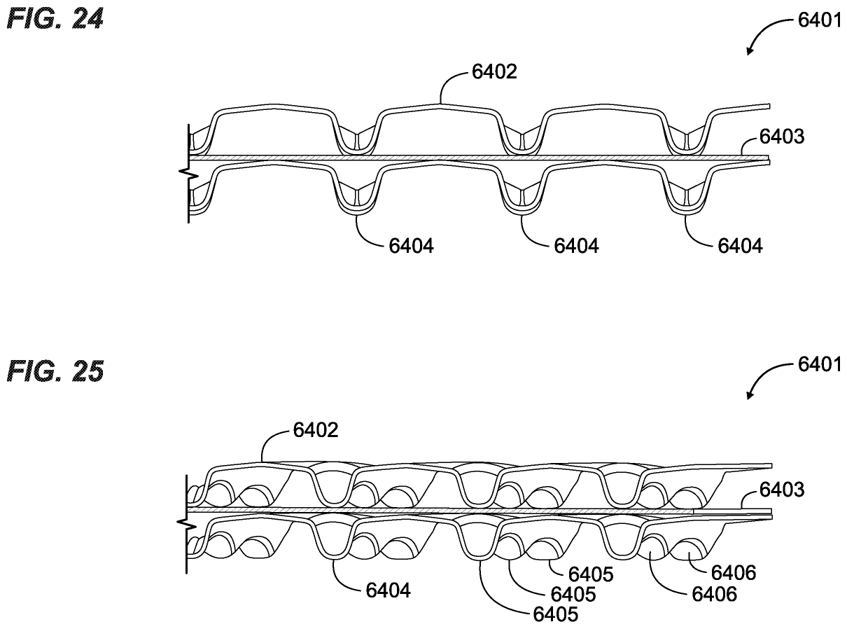

In FIGS. 24 and 25, an example media arrangement 6401 is depicted, in which a fluted sheet 6402 is secured to a facing sheet 6403. The facing sheet 6403 may be a flat sheet. The media arrangement 6401 can then be stacked or coiled into a media pack, with seals along opposite edges of the type previously described for FIG. 1 herein. In the embodiment shown, the flutes 6404 of fluted sheet 6402 have an undulating ridgeline including a series of peaks 6405 and saddles 6406. The peaks 6405 of adjacent flutes 6404 can be either aligned as shown in FIGS. 24 and 25 or offset. Further the peak height and/or density can increase, decrease, or remain constant along the length of the flutes 6404. The ratio of the peak flute height to saddle flute height can vary from about 1.5, typically from 1.1 to about 1.

It is noted that there is no specific requirement that the same media be used for the fluted sheet section and the facing sheet section. A different media can be desirable in each, to obtain different effects. For example, one may be a cellulose media, while the other is a media containing some non-cellulose fiber. They may be provided with different porosity or different structural characteristics, to achieve desired results.

A variety of materials can be used. For example, the fluted sheet section or the facing sheet section can include a cellulose material, synthetic material, or a mixture thereof. In some embodiments, one of the fluted sheet section and the facing sheet section includes a cellulose material and the other of the fluted sheet section and facing sheet section includes a synthetic material.

Synthetic material(s) can include polymeric fibers, such as polyolefin, polyamide, polyester, polyvinyl chloride, polyvinyl alcohol (of various degrees of hydrolysis), and polyvinyl acetate fibers. Suitable synthetic fibers include, for example, polyethylene terephthalate, polyethylene, polypropylene, nylon, and rayon fibers. Other suitable synthetic fibers include those made from thermoplastic polymers, cellulosic and other fibers coated with thermoplastic polymers, and multi-component fibers in which at least one of the components includes a thermoplastic polymer. Single and multi-component fibers can be manufactured from polyester, polyethylene, polypropylene, and other conventional thermoplastic fibrous materials.

The examples of FIGS. 18-25, are meant to indicate generally that a variety alternate media packs can be used in accord with the principles herein. Attention is also directed to U.S. Ser. No. 62/077,749 incorporated herein by reference, with respect to the general principles of construction and application of some alternates media types.

### Additional Media Pack Arrangements Including Pleated Media With Flutes; FIGS. 26-29

Additional examples of alternative types of media arrangements or packs that involve filtration media having flutes extending between opposite ends or flow faces in a straight through flow configuration are depicted in FIGS. 26-29. The flutes can be considered inlet flutes when they are arranged to receive dirty air via an inlet flow face, and they can be considered outlet flutes when they are arranged to permit filtered air to flow out via an outlet flow face.

The filtration media 6502 depicted in FIGS. 26-28, which is analogous to ones depicted in U.S. Pat. Nos. 8,479,924 and 9,919,256 assigned to Mann+Hummel GmbH, is illustrated in an arrangement that shows how the filtration media 6502 can be formed into a media pack arrangement 6504.

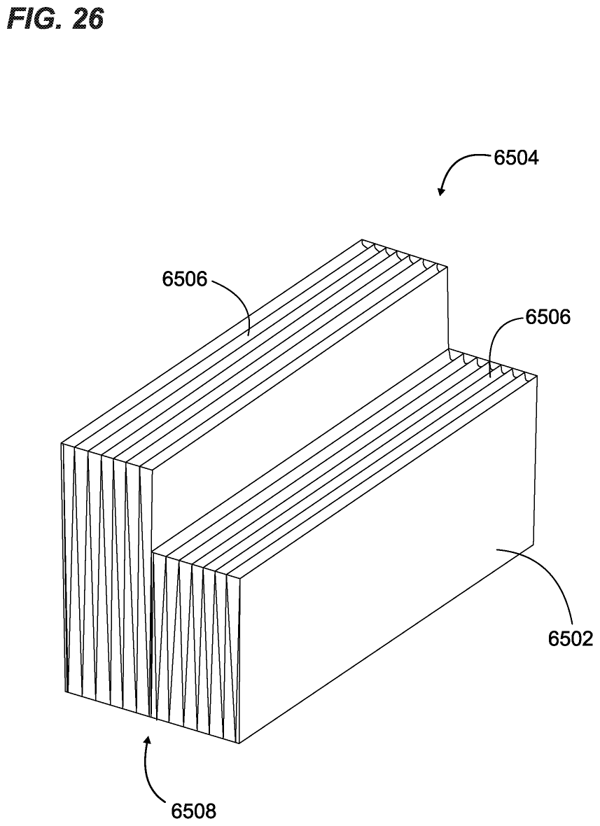

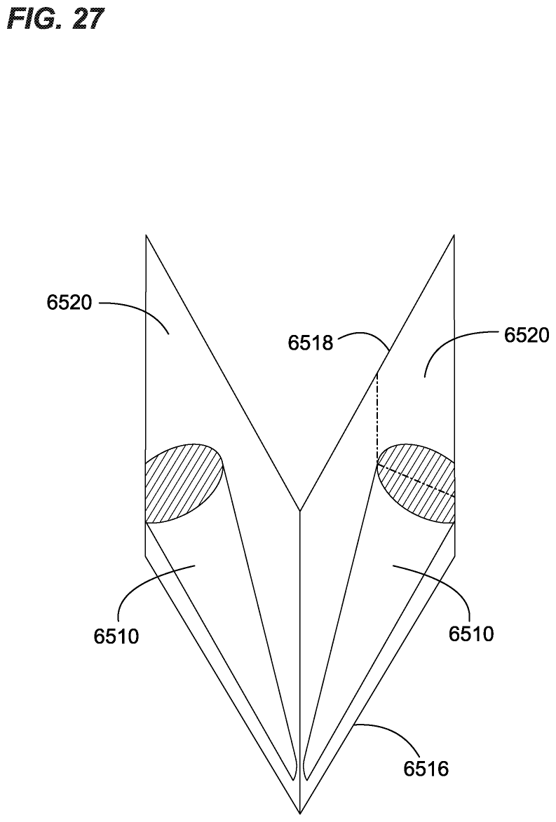

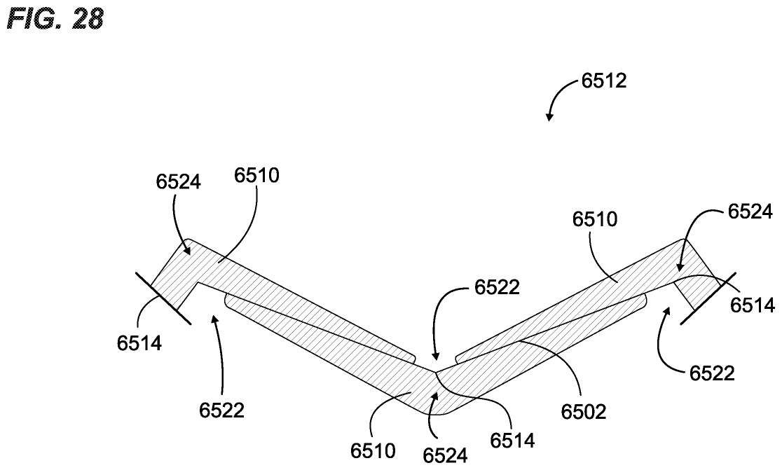

The media pack arrangement 6504 can be considered as having relatively long or deep pleats from an inlet flow face 6506 to an outlet flow face 6508, and can also have varying pleat depths as illustrated. As the depth of pleats of a media pack increases, there is a tendency of the filtration media to collapse on each other thereby causing masking. Masking is undesirable because masked filtration media tends to no longer be available for filtration thereby decreasing dust holding capacity and flow through the media pack, and also potentially increasing pressure drop across the media pack. In order to reduce masking and to help the filtration media retain its shape, support structures are known to be applied to pleated media. In FIGS. 27 and 28, support sections or spacers 6510 are provided. It should be appreciated that FIGS. 27 and 28 are illustrated in a folded configuration 6512 having pleat folds 6514, but are expanded or separated to show how the filtration media 6502 and the support sections or spacers 6510 can be arranged.

As illustrated in FIGS. 27 and 28, the filtration media 6502 extends between a first side 6516 and a second side 6518. Although only one support section 6510 is shown on each pleat face 6520, it should be appreciated that multiple support sections 6510 can be arranged along each pleat face 6520 so that when the filtration media 6502 is arranged into a media pack as illustrated in FIG. 26 as media pack 604, the volume between each of the support sections 6510 can be considered flutes extending between the inlet flow face 6506 and the outlet flow face 6508. The support sections 6510 can be arranged on each flow face 6520 so that opposite support sections 6510 contact or engage each other to help maintain the media pack shape while also limiting the amount of filtration media that would be contacted by the support sections 6510, as illustrated in FIG. 27. Furthermore, by providing that the support sections 6510 have adhesive properties, the support sections 6510 can be provided so that opposing support sections 6510 can adhere to each other when the filtration media 6502 is arranged into the media pack 6504.

The support sections 6510 can be arranged in a tapered configuration where support sections 6510 have a cross section at an interior fold 6522 and wherein the cross section increases toward an exterior fold 6524. In this context, the phrase “interior fold” refers to the side of the media that forms an acute angle, and the phrase “exterior fold” refers to the side of the media that forms an obtuse angle when the media is arranged into a media pack. Furthermore, the reference to changing the cross section of the support sections 6510 can refer to one or both of the height that the support section extends away from the media to which it is adhered and also to the width along the media to which it is adhered to in a direction toward or away from other support sections across adjacent flutes. Changing the shape of the support sections 6510 can help maintain the shape of the media pack and the resulting flutes, and can help reduce the amount of media that would otherwise be contacted by the support sections 6510 if they were not arranged in a tapered configuration. In addition, the support sections 6510 can be arranged in a non-tapered configuration. As illustrated in FIG. 28, the support sections 6510 can be provided so that they extend over the exterior folds 6524 although it is not necessary for the support sections 6510 to extend over the exterior folds. In addition, it is not necessary for the support sections 6510 to extend into the interior folds 6522, although, if desired, the support sections 6510 can be provided so that they extend into the interior folds 6522.

The support sections 6510 can be applied to the filtration media 6502 as adhesive extruded onto the filtration media 6502 where the adhesive forms the support sections 6510. Before the adhesive has a chance to fully cure, the filtration media 6502 can be folded into the media pack arrangement 6504, which may or may not have varying pleat depths. By forming the media pack arrangement 6504 before the adhesive has fully cured, the opposing support sections 6510 can become bonded or adhered to each other thereby forming flutes extending between the inlet flow face 6506 and the outlet flow face 6508.

It should be appreciated that the filtration media 6502 can be provided with deformation, such as corrugations, extending across the media. The direction of deformation, such as corrugation, can be parallel or perpendicular to the pleat fold direction.

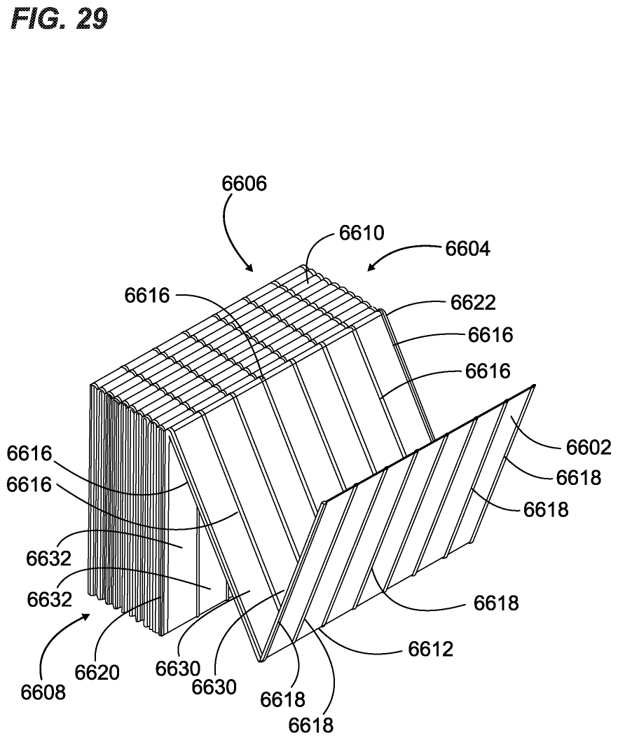

The filtration media 6602 depicted in FIG. 29 is analogous to filtration media depicted in US 2018/0207566 assigned to Champion Laboratories, Inc., as another example of a media pack arrangement 6604 having inlet and outlet flutes in a straight through flow arrangement.

The filtration media pack arrangement 6604 can be formed by folding the filtration media 6602 to form an inlet flow face 6606 and an outlet flow face 6608. The pleat tips 6610 form the inlet flow face 6606, and the pleat tips 6612 form the outlet flow face 6608. Adhesive beads 6616 and 6618, which may be continuous or discontinuous, extend along the filtration media 6602 in multiple lines across the filtration media 6602 from a media first side 6620 to a media second side 6622. The adhesive beads 6616 and 6618 along the media first side 6620 and along the media second side 6620 can be thickened, if desired, and can be arranged to provide an edge seal along the media first side 6620 and the media second side 6622. By providing that the adhesive beads 6616 and 6618 adhere to each other as the filtration media 6602 is folded, inlet flutes 6630 and outlet flutes 6632 can be formed in the straight through media pack arrangement 6604.

A similar type of filtration media pack arrangement is commercially available under the name Enduracube from Baldwin Filters, Inc. The filtration media pack available under the name Enduracube from Baldwin Filters, Inc. is arranged in a pleated configuration forming inlet flutes and outlet flutes extending between an inlet flow face and an outlet flow face.

What is claimed is:

1. A filter element comprising:
(a) a media pack having first and second opposite axial ends to provide straight through filter flow; and a side wall extending between the first and second axial ends;
(i) the media pack having first and second opposite flow faces and a plurality of flutes; each of the flutes having a first portion adjacent to the first flow face and a second portion adjacent to second flow face; selected ones of the flutes being open at the first portion and closed at the second portion, and adjacent flutes being closed at the first portion and open at the second portion;
(ii) the first flow face being an outflow face, and the second flow face being an inflow face;
(b) a gasket support secured to the media pack; the gasket support having an annular wall and a plate extending radially therefrom and away from the media pack;
(i) the plate having a first axial surface away from the media pack, and an opposite second axial surface toward the annular wall;
(ii) a gasket member secured to the second axial surface of the plate; the gasket member being radially spaced from the annular wall of the gasket support and from the side wall of the media pack by a receiving cavity, and extending in a direction toward the media pack; and
(c) a deflector secured to the first flow face.

2. The filter element of claim 1, further including a center bar extending across the first flow face.

3. The filter element of claim 2, wherein the center bar is an integral part of the gasket support.

4. The filter element of claim 3, wherein the annular wall of the gasket support has an inner wall surface facing the side wall of the media pack and an opposite outer wall surface facing the gasket member, with the receiving cavity being between the outer wall surface and the gasket member.

5. The filter element of claim 3, wherein the gasket support further includes a lip extending radially inwardly from the annular wall; the lip being oriented on a portion of the first flow face.

6. The filter element of claim 5, wherein the center bar bisects the first flow face and extends from the lip of the gasket support.

7. The filter element of claim 2, wherein the deflector is connected to the center bar.

8. The filter element of claim 1, wherein the deflector has a curved, solid surface projecting from the first flow face.

9. The filter element of claim 1, further including a handle secured to the media pack.

10. The filter element of claim 9, wherein the handle is an integral part of the gasket support.

11. The filter element of claim 10, wherein the handle comprises a tab radially extending from the plate in a direction radially away from the media pack.

12. The filter element of claim 1, wherein the gasket member has opposite straight sides extending from the second axial surface of the plate, joined by a straight terminal surface.

13. The filter element of claim 1, wherein the gasket member has opposite straight sides extending from the second axial surface of the plate, joined by a rounded terminal surface.

14. The filter element of claim 1, wherein the gasket member is polygon shaped.

15. The filter element of claim 14, wherein the polygon shaped gasket member is irregularly shaped.

16. The filter element of claim 14, wherein the polygon shaped gasket member is any one of: pentagon-shaped, hexagon shaped, heptagon shaped, and triangle-shaped.

17. The filter element of claim 12, wherein the gasket member is only secured to the second axial surface of the plate, and is free of attachment to any other portion of the gasket support.

18. The filter element of claim 12, wherein the annular wall has a length longer than a length of the gasket member.

19. The filter element of claim 1, wherein the receiving cavity has an outermost width at least 70% of an outermost width of the gasket member.

20. The filter element of claim 1, wherein the receiving cavity has an outermost width at least 80% of an outermost width of the gasket member.

21. The filter element of claim 1, wherein the media pack is racetrack shaped, having a pair of first and second parallel sides, joined by opposite first and second curved ends.

22. The filter element of claim 21, wherein the deflector is secured to the first flow face in a region within 25% of a length of the first flow face from the first curved end.

23. The filter element of claim 11, wherein:
(a) the media pack is racetrack shaped, having a pair of first and second parallel sides, joined by opposite first and second curved ends; and
(b) the tab extends radially from the plate at the second curved end.

24. The filter element of claim 2, wherein:
(a) the media pack is racetrack shaped, having a pair of first and second parallel sides, joined by opposite first and second curved ends; and
(b) the center bar extends between the first curved end and second curved end.

25. The filter element of claim 2, wherein the only structure over the first flow face is the center bar and deflector; the first flow face otherwise being open and unobstructed.

26. The filter element of claim 1, wherein the media pack is polygon shaped.

27. The filter element of claim 1, wherein the gasket member is molded to the second axial surface of the plate.
